(19) United States
(12) Patent Application Publication
(10) Pub. No.: US 2024/0363978 A1
(43) Pub. Date: Oct. 31, 2024

(54) BATTERY AND BATTERY MANUFACTURING METHOD

(71) Applicant: Panasonic Intellectual Property Management Co., Ltd., Osaka (JP)

(72) Inventors: Kazuyoshi HONDA, Osaka (JP); Koichi HIRANO, Osaka (JP); Eiichi KOGA, Hokkaido (JP); Kazuhiro MORIOKA, Osaka (JP); Tsutomu KOSHIZUKA, Osaka (JP); Akira KAWASE, Osaka (JP)

(21) Appl. No.: 18/770,210

(22) Filed: Jul. 11, 2024

Related U.S. Application Data
(63) Continuation of application No. PCT/JP2022/043292, filed on Nov. 24, 2022.

(30) Foreign Application Priority Data
Jan. 25, 2022 (JP) 2022-009743

(51) Int. Cl. H01M 50/533; H01M 4/64; H01M 10/0562; H01M 10/0585; H01M 50/591

(52) U.S. Cl. CPC H01M 50/533; H01M 4/64; H01M 10/0562; H01M 10/0585; H01M 50/591

(57) ABSTRACT

A battery includes: a power generating element having a stacked structure of power generating layers and current collectors; and a counter electrode terminal. Each of the power generating layers is sandwiched between two adjacent ones of the current collectors. The current collectors are not in contact with each other. At least one of the current collectors includes a protruding portion protruding beyond an end surface of the power generating layer in a side surface portion of the power generating element and a stacked portion in which the power generating layers are stacked. When the protruding portion and the stacked portion are projected onto a projection plane perpendicular to the main surfaces of the power generating layers, the projected area of the protruding portion is larger than the projected area of the stacked portion. The counter electrode terminal is connected to a main surface of the protruding portion.

### CROSS REFERENCE TO RELATED APPLICATIONS

This is a continuation application of PCT International Application No. PCT/JP2022/043292 filed on Nov. 24, 2022, designating the United States of America, which is based on and claims priority of Japanese Patent Application No. 2022-009743 filed on Jan. 25, 2022. The entire disclosures of the above-identified applications, including the specifications, drawings, and claims are incorporated herein by reference in their entirety.

### FIELD

The present disclosure relates to a battery and a battery manufacturing method.

### BACKGROUND

Patent Literature (PTL) 1 discloses batteries in which a plurality of unit cells stacked and connected in series are connected in parallel at their end surfaces.

PTL 2 discloses batteries in which a plurality of unit cells stacked and connected in series are connected in parallel at their end surfaces by protruding current collectors.

### CITATION LIST

### Patent Literature

PTL 1: Japanese Unexamined Patent Application Publication No. 2013-120717
PTL 2: Japanese Unexamined Patent Application Publication No. 2008-198492

### SUMMARY

### Technical Problem

Further improvement in the high current characteristics and reliability of batteries is desired in conventional techniques.

In stacked batteries, it is important to achieve high energy density and to make convenient and reliable connections using battery cells, each of which is a stacked unit cell.

However, since the unit cells of stacked batteries are thin, it is difficult to secure a region for connection at the end surfaces.

In view of this, the present disclosure provides a high-performance battery and a manufacturing method thereof.

### Solution to Problem

A battery according to one aspect of the present disclosure includes: a power generating element having a stacked structure of a plurality of power generating layers and a plurality of current collectors; and a conductive component. Each of the plurality of power generating layers includes an electrode layer, a counter electrode layer, and a solid electrolyte layer positioned between the electrode layer and the counter electrode layer, and is sandwiched between two adjacent current collectors among the plurality of current collectors. Two adjacent power generating layers among the plurality of power generating layers are stacked with one of the plurality of current collectors interposed therebetween. The plurality of current collectors are not in contact with each other. At least one current collector among the plurality of current collectors includes a protruding portion and a stacked portion, the protruding portion protruding beyond an end surface of the plurality of power generating layers in a side surface portion of the power generating element, the stacked portion being connected to the protruding portion on a side of the protruding portion where the end surface is located, and being a portion in which the plurality of power generating layers are stacked. When the protruding portion and the stacked portion are projected from outside the side surface portion in a direction parallel to main surfaces of the plurality of power generating layers onto a projection plane perpendicular to the main surfaces of the plurality of power generating layers, a projected area of the protruding portion is larger than a projected area of the stacked portion. The conductive component is connected to a main surface of the protruding portion. In the side surface portion, the conductive component contacts an end surface of the electrode layer or the counter electrode layer adjacent to the at least one current collector.

A battery manufacturing method according to one aspect of the present disclosure includes: preparing a plurality of unit cells each having a structure in which a power generating layer and a current collecting layer are stacked, the power generating layer including an electrode layer, a counter electrode layer, and a solid electrolyte layer positioned between the electrode layer and the counter electrode layer; forming a stacked body in which: the plurality of power generating layers of the plurality of unit cells and a plurality of current collectors each including the current collecting layer are stacked; the plurality of power generating layers are each sandwiched between two adjacent current collectors among the plurality of current collectors; two adjacent power generating layers among the plurality of power generating layers are stacked with a current collector among the plurality of current collectors interposed therebetween; and the plurality of current collectors are not in contact with each other, the forming including stacking the plurality of unit cells and forming, on at least one current collector among the plurality of current collectors, a protruding portion that protrudes beyond an end surface of a power generating layer among the plurality of power generating layers in a side surface portion of the stacked body; and forming a conductive component that is connected to a main surface of the protruding portion and, in the side surface portion, contacts an end surface of the electrode layer or the counter electrode layer adjacent to the at least one current collector. In the forming of the stacked body, the protruding portion is formed to have a projected area larger than a projected area of a stacked portion of the at least one current collector when the protruding portion and the stacked portion are projected from outside the side surface portion in a direction parallel to a main surface of the power generating layer onto a projection plane perpendicular to the main surface of the power generating layer, the stacked portion being connected to the protruding portion on a side of the protruding portion where the end surface is located, and being a portion in which the plurality of power generating layers are stacked.

### Advantageous Effects

According to the present disclosure, it is possible to provide a high-performance battery and a manufacturing method thereof.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a cross-sectional view of a battery according to Embodiment 1.

FIG. 2 is a top view of a power generating element of a battery according to Embodiment 1.

FIG. 3 is a cross-sectional view for explaining the detailed structure of a current collector of a battery according to Embodiment 1.

FIG. 4 is for explaining the projected area of a current collector of a battery according to Embodiment 1.

FIG. 5 is a plan view of a power generating element of a battery according to Embodiment 1 when viewed from the side.

FIG. 6 is a cross-sectional view of a power generating element of a battery according to Embodiment 1.

FIG. 7 is another plan view of a power generating element of a battery according to Embodiment 1 when viewed from the side.

FIG. 8 is a plan view illustrating the positional relationship between a side surface portion of a power generating element according to Embodiment 1 and electrode insulating layers on the side surface portion.

FIG. 9 is a plan view illustrating the positional relationship between a side surface portion of a power generating element according to Embodiment 1 and electrode insulating layers and a counter electrode terminal on the side surface portion.

FIG. 10 is a plan view illustrating the positional relationship between a side surface portion of a power generating element according to a variation of Embodiment 1 and electrode insulating layers on the side surface portion.

FIG. 11 is a plan view of a battery according to a variation of Embodiment 1 when viewed from the side.

FIG. 12 is a cross-sectional view of a battery according to Embodiment 2.

FIG. 13 is a cross-sectional view of a battery according to Embodiment 3.

FIG. 14 is a cross-sectional view of a battery according to Embodiment 4.

FIG. 15 is a cross-sectional view for explaining the detailed structure of a current collector of a battery according to Embodiment 4.

FIG. 16 is a cross-sectional view of a battery according to Embodiment 5.

FIG. 17 is a cross-sectional view for explaining the detailed structure of a current collector of a battery according to Embodiment 5.

FIG. 18 is a cross-sectional view of a battery according to Embodiment 6.

FIG. 19 is a cross-sectional view for explaining the detailed structure of a current collector of a battery according to Embodiment 6.

FIG. 20 is a cross-sectional view of a battery according to Embodiment 7.

FIG. 21 is a cross-sectional view of a battery according to Embodiment 8.

FIG. 22 is a plan view illustrating the positional relationship between a side surface portion of a power generating element according to Embodiment 8 and an insulating layer and connection terminals on the side surface portion.

FIG. 23 is a plan view of a battery according to a variation of Embodiment 8 when viewed from the side.

FIG. 24 is flowchart illustrating Manufacturing Method Example 1 for a battery according to an embodiment.

FIG. 25A is a cross-sectional view of one example of a unit cell according to an embodiment.

FIG. 25B is a cross-sectional view of another example of a unit cell according to an embodiment.

FIG. 25C is a cross-sectional view of another example of a unit cell according to an embodiment.

FIG. 26 is flowchart illustrating Manufacturing Method Example 2 for a battery according to an embodiment.

FIG. 27 is flowchart illustrating Manufacturing Method Example 3 for a battery according to an embodiment.

### DESCRIPTION OF EMBODIMENT(S)

### Overview of Present Disclosure

The following are examples of a battery and a battery manufacturing method according to the present disclosure.

A battery according to a first aspect of the present disclosure includes: a power generating element having a stacked structure of a plurality of power generating layers and a plurality of current collectors; and a conductive component. Each of the plurality of power generating layers includes an electrode layer, a counter electrode layer, and a solid electrolyte layer positioned between the electrode layer and the counter electrode layer, and is sandwiched between two adjacent current collectors among the plurality of current collectors. Two adjacent power generating layers among the plurality of power generating layers are stacked with one of the plurality of current collectors interposed therebetween. The plurality of current collectors are not in contact with each other. At least one current collector among the plurality of current collectors includes a protruding portion and a stacked portion, the protruding portion protruding beyond an end surface of the plurality of power generating layers in a side surface portion of the power generating element, the stacked portion being connected to the protruding portion on a side of the protruding portion where the end surface is located, and being a portion in which the plurality of power generating layers are stacked. When the protruding portion and the stacked portion are projected from outside the side surface portion in a direction parallel to main surfaces of the plurality of power generating layers onto a projection plane perpendicular to the main surfaces of the plurality of power generating layers, a projected area of the protruding portion is larger than a projected area of the stacked portion. The conductive component is connected to a main surface of the protruding portion. In the side surface portion, the conductive component contacts an end surface of the electrode layer or the counter electrode layer adjacent to the at least one current collector.

This makes it possible to realize a high-performance battery. For example, a battery with enhanced reliability, energy density, and high current characteristics can be realized.

More specifically, since the protruding portion protrudes beyond the end surfaces of the power generating layers, the conductive component can be connected to the main surfaces of the protruding portion to draw out current. Therefore, compared to connecting the conductive component to the end surface of the current collector, the connection area between the conductive component and the current collector can be increased and the resistance of the connection area can be reduced, thus inhibiting voltage drop and heat generation at the connection area and enhancing high current characteristics. In addition, the increased connection area between the conductive component and current collector increases the mechanical connection strength between the conductive component and current collector, thereby enhancing battery reliability. Moreover, by the conductive component being in contact with the electrode layer or the counter electrode layer, the reliability of the electrical connection of the battery improves, and the mechanical strength of the battery also improves since the protruding portion is stably held by the conductive component.

Furthermore, the projected area of the protruding portion is larger than the projected area of the stacked portion, resulting in a structure in which the protruding portion extends beyond the stacked portion in the stacking direction. Therefore, when the protruding portion is connected to the conductive component, the protruding portion can bite into the conductive component, and the mechanical connection between the current collector and the conductive component can be strengthened by the anchoring effect. When compared with a configuration in which the height from the end surface of the power generating layer to the leading end of the protruding portion is the same, the area of the main surface of the protruding portion is larger than when the projected area of the protruding portion is the same as the projected area of the stacked portion. As a result, the connection area when a conductive component is connected to the main surface of the protruding portion can be increased. Stated differently, the connection area when a conductive component is connected to the main surface of the protruding portion without increasing the size of the battery as a whole can be increased. Thus, both high energy density and high current characteristics can be achieved.

According to a second aspect of the present disclosure, for example, in the battery according to the first aspect, the protruding portion may include a bend or a curve.

With this, a protruding portion with a large projected area can be easily formed.

According to a third aspect of the present disclosure, for example, in the battery according to the second aspect, a maximum angle of the bend or the curve included in the protruding portion may be 90 degrees or less with respect to the stacked portion.

With this, a conductive component connected to the protruding portion can be easily formed.

According to a fourth aspect of the present disclosure, for example, in the battery according to the second aspect, a maximum angle of the bend or the curve included in the protruding portion may be between 1 and 45 degrees, inclusive, with respect to the stacked portion.

With this, a conductive component connected to the protruding portion can be easily formed and the mechanical connection strength between the current collector and the conductive component can be increased.

According to a fifth aspect of the present disclosure, for example, in the battery according to the first aspect, the protruding portion may include a portion that is thicker than the stacked portion. With this, the projected area of the protruding portion can be increased while the electrical resistance of the protruding portion itself is reduced.

According to a sixth aspect of the present disclosure, for example, in the battery according to the fifth aspect, the portion of the protruding portion that is thicker than the stacked portion may have a maximum thickness that is at least 1.5 times a thickness of the stacked portion.

This effectively increases the mechanical connection strength and connection area between the current collector and the conductive component.

According to a seventh aspect of the present disclosure, for example, in the battery according to the first aspect, the protruding portion may be bifurcated.

This facilitates a larger surface area of the protruding portion, effectively increasing the connection area between the protruding portion and the conductive component.

According to an eighth aspect of the present disclosure, for example, in the battery according to any one of the first through seventh aspects, the side surface portion may include a region, located on both sides of the protruding portion in a direction parallel to the main surfaces of the plurality of power generating layers in the side surface portion, in which the at least one current collector does not protrude beyond the end surface of the plurality of power generating layers.

This makes it difficult for the protruding portion to move, as both sides of the protruding portions are supported by the power generating layer, which moderately limits the freedom of movement of the protruding portion. The protruding portions are therefore inhibited from moving and contacting each other during the battery manufacturing process, thus inhibiting a short circuit.

According to a ninth aspect of the present disclosure, for example, in the battery according to any one of the first through eighth aspects, a length of protrusion of the protruding portion is at least twice a thickness of the stacked portion.

This means that when the entire protruding portion is connected to the conductive component, the connection area is five times larger than when only the end surface of the current collector is connected to the conductive component.

According to a tenth aspect of the present disclosure, for example, in the battery according to any one of the first through ninth aspects, a height of a leading end of the protruding portion from the end surface of the plurality of power generating layers may be less than or equal to a thickness of the power generating element. According to an eleventh aspect of the present disclosure, for example, in the battery according to any one of the first through ninth aspects, a height of a leading end of the protruding portion from the end surface of the plurality of power generating layers may be less than or equal to twice a thickness of one power generating layer among the plurality of power generating layers.

This allows the connection points of the conductive component in the battery to be downsized and increases the energy density of the battery.

According to a twelfth aspect of the present disclosure, for example, in the battery according to any one of the first through eleventh aspects, the plurality of power generating layers may be electrically connected in parallel.

This makes it possible to realize a large-capacity battery.

According to a thirteenth aspect of the present disclosure, for example, in the battery according to any one of the first through eleventh aspects, the plurality of power generating layers may be electrically connected in series.

This makes it possible to realize a high-voltage battery.

According to a fourteenth aspect of the present disclosure, for example, in the battery according to the twelfth aspect, the plurality of current collectors may include a counter electrode current collector electrically connected to the counter electrode layer and an electrode current collector electrically connected to the electrode layer. The at least one current collector may be the counter electrode current collector. The battery may further include, in the side surface portion, an insulating component that covers the electrode layer and the electrode current collector. In the side surface portion, the conductive component may cover the insulating component and be connected to the protruding portion of the counter electrode current collector.

This inhibits the occurrence of a short circuit between the counter electrode layer and the electrode layer through the conductive component since the insulating component covers the electrode layer and electrode current collector at the side surface portion.

According to a fifteenth aspect of the present disclosure, for example, in the battery according to the fourteenth aspect, in the side surface portion, the insulating component may contact at least a portion of the solid electrolyte layer.

By forming the insulating component so that it contacts up to part of the solid electrolyte layer, it is possible to inhibit the electrode layer from being exposed without being covered by the insulating component, even when there are variations in the size of the insulating component. In addition, since the solid electrolyte layer is generally formed of powdery material, there are very fine irregularities on its sides. This improves the adhesion strength of the insulating component and thus improves insulation reliability.

According to a sixteenth aspect of the present disclosure, for example, in the battery according to the fourteenth or fifteenth aspect, in the side surface portion, with respect to each of the plurality of power generating layers, the insulating component may cover the electrode layer in the power generating layer and the electrode current collector electrically connected to the electrode layer in the power generating layer. In the side surface portion, with respect to each of the plurality of power generating layers, the conductive component may be connected to the counter electrode current collector electrically connected to the counter electrode layer in the power generating layer.

This allows the use of conductive components for parallel connection of a plurality of power generating layers. The conductive component can be made to adhere closely to the side surface portion and insulating component, thus reducing the volume of the region involved in the parallel connection. This allows the energy density of the battery to be increased.

A battery manufacturing method according to a seventeenth aspect of the present disclosure includes: preparing a plurality of unit cells each having a structure in which a power generating layer and a current collecting layer are stacked, the power generating layer including an electrode layer, a counter electrode layer, and a solid electrolyte layer positioned between the electrode layer and the counter electrode layer; forming a stacked body in which: the plurality of power generating layers of the plurality of unit cells and a plurality of current collectors each including the current collecting layer are stacked; the plurality of power generating layers are each sandwiched between two adjacent current collectors among the plurality of current collectors; two adjacent power generating layers among the plurality of power generating layers are stacked with a current collector among the plurality of current collectors interposed therebetween; and the plurality of current collectors are not in contact with each other, the forming including stacking the plurality of unit cells and forming, on at least one current collector among the plurality of current collectors, a protruding portion that protrudes beyond an end surface of a power generating layer among the plurality of power generating layers in a side surface portion of the stacked body; and forming a conductive component that is connected to a main surface of the protruding portion and, in the side surface portion, contacts an end surface of the electrode layer or the counter electrode layer adjacent to the at least one current collector. In the forming of the stacked body, the protruding portion is formed to have a projected area larger than a projected area of a stacked portion of the at least one current collector when the protruding portion and the stacked portion are projected from outside the side surface portion in a direction parallel to a main surface of the power generating layer onto a projection plane perpendicular to the main surface of the power generating layer, the stacked portion being connected to the protruding portion on a side of the protruding portion where the end surface is located, and being a portion in which the plurality of power generating layers are stacked.

This makes it possible to manufacture the above-described high-performance battery.

In an eighteenth aspect of the present disclosure, for example, in the battery manufacturing method according to the seventeenth aspect, in the forming of the stacked body, the protruding portion may be formed using at least one of the following methods on a material: dissolving; partial cutting; polishing; sandblasting; brushing; etching; plasma irradiation; laser irradiation; mechanical cutting; ultrasonic cutting; or pressing.

With this, a protruding portion can be easily formed.

Hereinafter, embodiments of the present disclosure will be described with reference to the drawings.

The embodiments described below each illustrate a general or a specific example. The numerical values, shapes, materials, elements, the arrangement and connection of the elements, steps, order of the steps, etc., shown in the following embodiments are mere examples, and therefore do not limit the scope of the present disclosure. Among the elements in the following exemplary embodiments, elements not recited in any one of the independent claims are described as optional elements.

The figures are schematic illustrations and are not necessarily precise depictions. Accordingly, the figures are not necessarily to scale. In the figures, the same reference signs are used for elements that are essentially the same. Accordingly, duplicate description is omitted or simplified.

In the present specification, terms indicating relationships between elements, such as “parallel”, terms indicating shapes of elements, such as “rectangular”, and numerical ranges are expressions that include, in addition to their exact meanings, substantially equivalent ranges, including differences of approximately a few percent, for example.

In the present specification and in the drawings, the x-, y-, and z-axes refer to the three axes of a three-dimensional Cartesian coordinate system. When the power generating element of the battery has a rectangular plan view shape, the x-axis is parallel to a first side of the rectangle and the y-axis is parallel to a second side of the rectangle that is orthogonal to the first side. The z-axis corresponds to the stacking direction of the plurality of power generating layers included in the power generating element. In the present specification, the “stacking direction” corresponds to the direction normal to the main surfaces of the current collectors and active material layers. In the present specification, unless otherwise specified, “plan view” means a view in a direction perpendicular to the main surface.

In the present specification, the terms “upward” and “downward” do not refer to the upward (vertically upward) and downward (vertically downward) directions in absolute spatial perception, but are used as terms defined by relative positions based on the stacking order in the stacked configuration. The terms “above” and “below” apply not only when two elements are arranged spaced apart from each other and another element is present between the two elements, but also when two elements are arranged in close contact with each other such that the two elements touch. In the following description, the negative direction of the z-axis corresponds to the direction referred to by terms like “down” or “lower” and the positive direction of the z-axis corresponds to the direction referred to by terms like “up” or “upper”.

In the present specification, unless otherwise specified, “protruding” means projecting outward from the center of the power generating element in a cross-sectional view perpendicular to the main surface of the power generating layer. The term “element A protrudes beyond element B” means that the leading end of element A protrudes more outwardly than the portion of element B adjacent to element A, i.e., the leading end of element A is further from the center of the power generating element than the portion of element B adjacent to element A. Elements include, for example, the electrode layer, the counter electrode layer, the solid electrolyte layer, the current collector, etc.

In the present specification, unless otherwise specified, ordinal numerals such as “first” and “second” do not refer to the number or order of elements, but are used to avoid confusion and to distinguish between like elements.

### Embodiment 1

First, the configuration of the battery according to Embodiment 1 will be described.

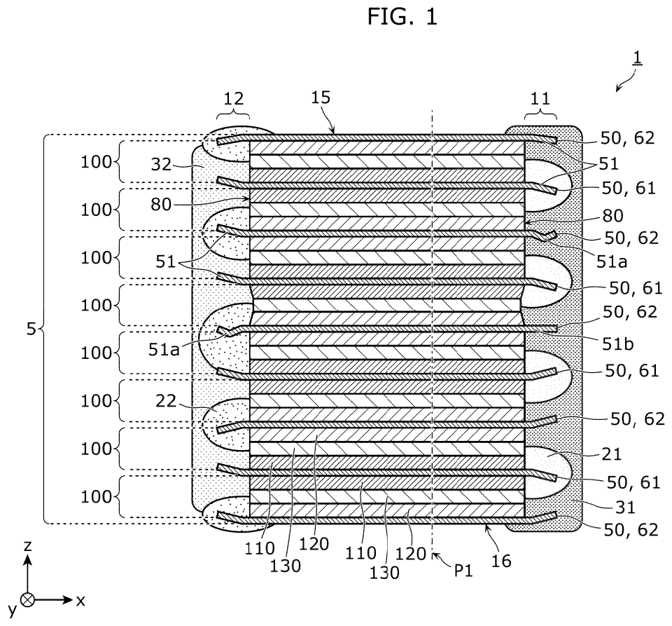

FIG. 1 is a cross-sectional view of battery 1 according to Embodiment 1. As illustrated in FIG. 1, battery 1 includes power generating element 5, electrode insulating layer 21, counter electrode insulating layer 22, counter electrode terminal 31, and electrode terminal 32. Battery 1 is, for example, an all solid-state battery.

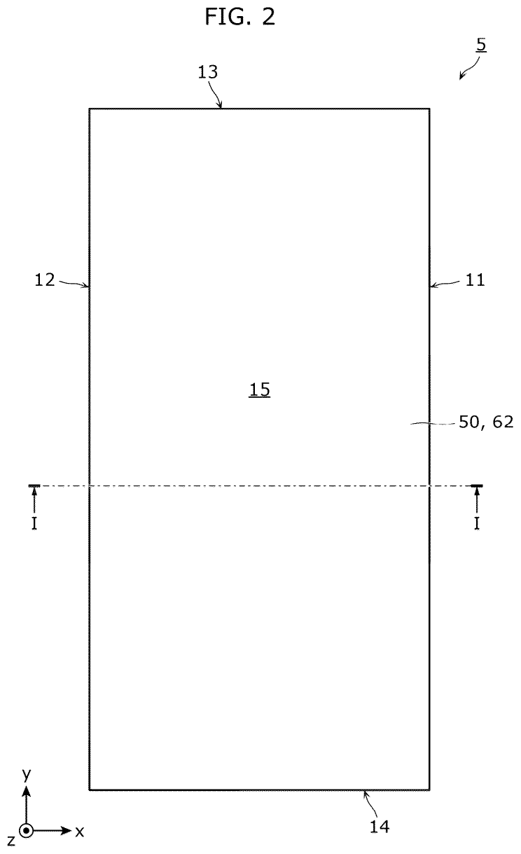

First, the specific configuration of power generating element 5 will be described with reference to FIG. 1 and FIG. 2. FIG. 2 is a top view of power generating element 5 of battery 1 according to the present embodiment. FIG. 1 is a cross-sectional view corresponding to a cross section taken at line I-I in FIG. 2.

As illustrated in FIG. 1 and FIG. 2, power generating element 5 has a structure in which a plurality of power generating layers 100 and a plurality of current collectors 50 are stacked in the thickness direction of the plurality of power generating layers 100.

As illustrated in FIG. 2, the plan view shape of power generating element 5 is, for example, rectangular. Stated differently, the general shape of power generating element 5 is a flat rectangular parallelepiped. Here, “flat” means that the thickness (i.e., the length in the z-axis direction) is shorter than each side of the main surface (i.e., the length in each of the x-axis direction and the y-axis directions) or the maximum width. The plan view shape of power generating element 5 may be some other polygonal shape such as square, hexagonal, or octagonal, and, alternatively, may be circular or elliptical. The outer edge of power generating element 5 in plan view may be uneven. In the drawings accompanying the present specification, the thickness of each layer is exaggerated in the cross-sectional views such as FIG. 1 and in the views looking at the sides straight on (to be described later) in order to more clearly convey the layered structure of power generating element 5.

As illustrated in FIG. 2, power generating element 5 includes four side surface portions 11, 12, 13, and 14 and two main surfaces 15 and 16. Side surface portions 11, 12, 13, and 14 correspond to the sides that connect main surfaces when power generating element 5 is viewed as a plate. Side surface portions 11, 12, 13, and 14 are the areas exposed on the lateral sides, which are the areas in directions of extension of the main surfaces of power generating layers 100 extend (i.e., directions perpendicular to the stacking direction) when power generating element 5 is in a standalone state (i.e., a state without electrode insulating layer 21, counter electrode insulating layer 22, counter electrode terminal 31, and electrode terminal 32 according to the present embodiment). Side surface portions 11, 12, 13, and 14 are portions corresponding to the end portions of the plurality of power generating layers 100 and the plurality of current collectors 50 in a direction perpendicular to the stacking direction.

Side surface portion 11 and side surface portion 12 face away from each other. Side surface portion 11 and side surface portion 12 each include a different one of the two parallel long sides of main surface 15.

Side surface portion 13 and side surface portion 14 face away from each other. Side surface portion 13 and side surface portion 14 each include a different one of the two parallel short sides of main surface 15.

Main surface 15 and main surface 16 face away from and are parallel to each other. Main surface 15 is the uppermost surface of power generating element 5. Main surface 16 is the lowermost surface of power generating element 5. Both main surfaces 15 and 16 are flat surfaces except at the end portions.

Hereinafter, a detailed description of each element included in power generating element 5 will be given.

As illustrated in FIG. 1 and FIG. 2, power generating element 5 includes a plurality of power generating layers 100 and a plurality of current collectors 50. Power generating layer 100 is the smallest component of the power generating portion of the battery and is also referred to as a unit cell. Power generating layer 100 and current collector 50 connected to power generating layer 100 may be collectively referred to as a unit cell. A plurality of power generating layers 100 are stacked so as to be electrically connected in parallel. In the present embodiment, all power generating layers 100 that power generating element 5 includes are stacked so as to be electrically connected in parallel. In the illustrated example, power generating element 5 includes eight power generating layers 100. However, power generating element 5 is not limited to this example. For example, power generating element 5 may include an even number of power generating layers 100, such as two or four, or an odd number, such as three or five.

Each of the plurality of power generating layers 100 includes electrode layer 110, counter electrode layer 120, and solid electrolyte layer 130. Electrode layer 110 and counter electrode layer 120 each include an active material and are also referred to as the electrode active material layer and the counter electrode active material layer, respectively. In each of the plurality of power generating layers 100, electrode layer 110, solid electrolyte layer 130, and counter electrode layer 120 are stacked along the z-axis in the listed order.

Electrode layer 110 is one of the cathode layer or the anode layer of power generating layer 100. Counter electrode layer 120 is the other of the cathode layer or the anode layer of power generating layer 100. In the following, as one example, electrode layer 110 is described as the anode layer and counter electrode layer 120 is described as the cathode layer.

The configuration of each power generating layer 100 is substantially the same. In two adjacent power generating layers 100, the order in which the layers of power generating layer 100 are stacked is reversed. Stated differently, the plurality of power generating layers 100 are stacked along the z-axis, and the order in which the layers of power generating layer 100 are layered alternate. Thus, a plurality of power generating layers 100 are stacked so as to be electrically connected in parallel. In the present embodiment, since the number of power generating layers 100 is even, the bottom-most and top-most layers in power generating element 5 are the same polarity.

Two adjacent power generating layers 100 are stacked with one of the plurality of current collectors 50 interposed therebetween. Each of the plurality of power generating layers 100 of power generating element 5 is sandwiched between two adjacent current collectors 50.

The plurality of current collectors 50 include electrode current collector 61 electrically connected to electrode layer 110 and counter electrode current collector 62 electrically connected to counter electrode layer 120. In the present specification, “electrically connected” means electrically connected so that they are substantially at the same potential, unless otherwise specified.

Electrode layer 110 is stacked on at least one main surface of electrode current collector 61 without solid electrolyte layer 130 interposed therebetween. Counter electrode layer 120 is stacked on at least one main surface of counter electrode current collector 62 without solid electrolyte layer 130 interposed therebetween.

The plurality of current collectors 50 are not in contact with each other. Therefore, electrode current collectors 61 are not in direct contact with each other, and but rather are electrically connected via electrode terminal 32 in order to connect power generating layers 100 in parallel. Furthermore, counter electrode current collectors 62 are not in direct contact with each other, and but rather are electrically connected via counter electrode terminal 31 in order to connect power generating layers 100 in parallel. Since there is no need to extend the end portions of current collectors 50, the size of the connection structure can be reduced compared to when the end portions of current collectors 50 are bundled together to form a parallel connection.

Current collector 50 is a conductive foil, plate, or mesh-like component. Current collector 50 may be, for example, a conductive thin film. In the example illustrated in FIG. 1, current collector 50 is a single metal foil.

Current collector 50 may have a multilayer structure including a plurality of current collecting layers of a plurality of metal foils or the like. In such cases, a plurality of current collecting layers are stacked either directly or with intermediate layers therebetween.

For example, metals such as stainless steel (SUS), aluminum (Al), copper (Cu), and nickel (Ni) can be used for current collector 50. Among the plurality of current collectors 50, electrode current collectors 61 and counter electrode current collectors 62 may be formed using different materials.

The thickness of current collector 50 is, for example, but not limited to, between 5 μm and 200 μm, inclusive.

Electrode layer 110 is in contact with the main surface of electrode current collector 61. Electrode current collector 61 may include a connection layer, which is a layer including a conductive material, provided at the portion in contact with electrode layer 110. Counter electrode layer 120 is in contact with the main surface of counter electrode current collector 62. Counter electrode current collector 62 may include a connection layer, which is a layer including a conductive material, provided at the portion in contact with counter electrode layer 120.

Electrode layer 110 is arranged on the main surface of electrode current collector 61. Electrode layer 110 includes, for example, an anode active material as the electrode material. Electrode layer 110 is arranged opposing counter electrode layer 120.

Anode active materials such as graphite and metallic lithium, for example, can be used as the anode active material included in electrode layer 110. Various materials that can release and insert ions, such as lithium (Li) or magnesium (Mg), can be used as the anode active material.

A solid electrolyte, such as an inorganic solid electrolyte, for example, may be further used as a material included in electrode layer 110. For example, a sulfide solid electrolyte or an oxide solid electrolyte can be used as the inorganic solid electrolyte. For example, a mixture of lithium sulfide (LizS) and diphosphorus pentasulfide (P₂S₅) can be used as the sulfide solid electrolyte. A conducting agent, such as acetylene black, or a binder, such as polyvinylidene fluoride, for example, may be further used as a material included in electrode layer 110.

Electrode layer 110 is made by coating a paste-like paint, in which the materials to be included in electrode layer 110 are kneaded together with a solvent, onto a main surface of electrode current collector 61 and allowing it to dry, for example. To increase the density of electrode layer 110, electrode current collector 61 coated with electrode layer 110 (also called an electrode plate) may be pressed after drying. The thickness of electrode layer 110 is, for example, but not limited to, between 5 μm and 300 μm, inclusive.

Counter electrode layer 120 is arranged on the main surface of counter electrode current collector 62. Counter electrode layer 120 is a layer including a cathode material such as an active material, for example. The cathode material is the material that constitutes a counter electrode to the anode material. Counter electrode layer 120 includes, for example, a cathode active material.

Examples of the cathode active material included in counter electrode layer 120 include, for example, lithium cobalt oxide (LCO), lithium nickel oxide (LNO), lithium manganese oxide (LMO), lithium-manganese-nickel oxide (LMNO), lithium-manganese-cobalt oxide (LMCO), lithium-nickel-cobalt oxide (LNCO), and lithium-nickel-manganese-cobalt oxide (LNMCO). Various materials that can release and insert ions, such as Li or Mg, can be used as the cathode active material.

A solid electrolyte, such as an inorganic solid electrolyte, for example, may be further used as a material included in counter electrode layer 120. A sulfide solid electrolyte or an oxide solid electrolyte can be used as the inorganic solid electrolyte. For example, a mixture of Li₂S and P₂S₅ can be used as the sulfide solid electrolyte. The surface of the cathode active material may be coated with a solid electrolyte. A conducting agent, such as acetylene black, or a binder, such as polyvinylidene fluoride, for example, may be further used as a material included in counter electrode layer 120.

Counter electrode layer 120 is made by coating a paste-like paint, in which the materials to be included in counter electrode layer 120 are kneaded together with a solvent, onto a main surface of counter electrode current collector 62 and allowing it to dry, for example. To increase the density of counter electrode layer 120, counter electrode current collector 62 coated with counter electrode layer 120 (also called a counter electrode plate) may be pressed after drying. The thickness of counter electrode layer 120 is, for example, but not limited to, between 5 μm and 300 μm, inclusive.

Solid electrolyte layer 130 is arranged between electrode layer 110 and counter electrode layer 120. Solid electrolyte layer 130 contacts each of electrode layer 110 and counter electrode layer 120. Solid electrolyte layer 130 is a layer including an electrolyte material. The electrolyte material may be a generally known electrolyte used for batteries. The thickness of solid electrolyte layer 130 may be between 5 μm and 300 μm, inclusive, or between 5 μm and 100 μm, inclusive.

Solid electrolyte layer 130 includes a solid electrolyte. For example, a solid electrolyte such as an inorganic solid electrolyte can be used as the solid electrolyte. A sulfide solid electrolyte or an oxide solid electrolyte can be used as the inorganic solid electrolyte. For example, a mixture of Li₂S and P₂S₅ can be used as the sulfide solid electrolyte. In addition to the electrolyte material, solid electrolyte layer 130 may include a binder such as polyvinylidene fluoride, for example.

In the present embodiment, electrode layer 110, counter electrode layer 120, and solid electrolyte layer 130 are maintained as parallel plates. This inhibits the occurrence of cracking or collapse due to curvature. Electrode layer 110, counter electrode layer 120, and solid electrolyte layer 130 may be smoothly curved together.

In power generating layer 100, for example, the shape and size of each of electrode layer 110, solid electrolyte layer 130, and counter electrode layer 120 are the same in plan view, and their respective contours match. The size of each power generating layer 100 is substantially the same. More specifically, after the stacked body corresponding to power generating element 5 is formed, the plurality of power generating layers 100 are cut as a batch, and then side surface portions 11 and 12 are formed by a process of receding power generating layers 100 from current collectors 50 and bending or curving the end portions of current collectors 50. Power generating layers 100 can be formed to have the same size by aligning the cutting direction with the stacking direction and performing the receding process evenly. By employing the batch cutting and receding process, for example, there is no gradual increase or decrease in thickness at the beginning or end of each layer's coating, and the respective areas of electrode layer 110, counter electrode layer 120, and solid electrolyte layer 130 are accurately defined. This reduces capacity variation among the plurality of power generating layers 100, thereby increasing battery capacity accuracy.

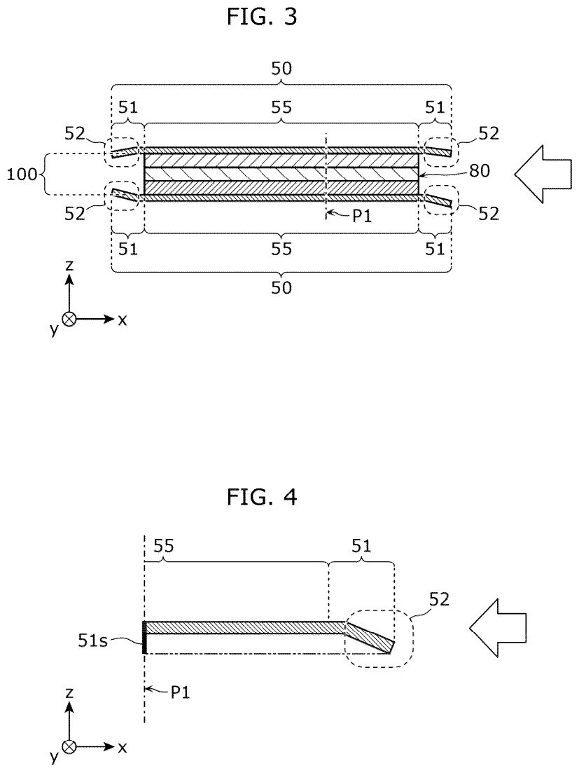

Next, the end portion structures of power generating layer 100 and current collector 50 will described in detail with reference to FIG. 1, FIG. 3, and FIG. 4.

FIG. 3 is a cross-sectional view for explaining the detailed structure of current collector 50 of battery 1 according to the present embodiment. FIG. 4 is for explaining the projected area of current collector 50 of battery 1 according to the present embodiment. FIG. 3 is an extracted view illustrating one power generating layer 100 and two adjacent current collectors 50 provided on either side of power generating layer 100, from among the plurality of power generating layers 100 and the plurality of current collectors 50 in power generating element 5 of battery 1. FIG. 4 illustrates an enlarged view of the region of current collector 50 that is farther outward relative to virtual projection plane P1.

As illustrated in FIG. 1 and FIG. 3, current collector 50 includes protruding portion 51 that protrudes beyond end surfaces 80 of the plurality of power generating layers 100 in side surface portion 11, and stacked portion 55 where the plurality of power generating layers 100 are stacked. Protruding portion 51 and stacked portion 55 are names given to different regions of one current collector 50. At end surface 80, most (for example, more than 90%) of electrode layer 110, solid electrolyte layer 130, and counter electrode layer 120 are terminated. End surface 80 is, for example, a flat surface, but end surface 80 may have an unevenness resulting from the manufacturing process of battery 1, for example, from stacking power generating layer 100 and current collector 50, cutting the stacked body, or forming protruding portion 51.

Current collector 50 also includes, in side surface portion 12, protruding portion 51 that protrudes beyond end surfaces 80 of the plurality of power generating layers 100. Hereinafter, protruding portion 51 in side surface portion 11 will be described, but protruding portion 51 in side surface portion 12 has the same configuration and thus the description of protruding portion 51 in side surface portion 11 also applies to protruding portion 51 in side surface portion 12.

Protruding portion 51 specifically protrudes beyond the end surface of electrode layer 110 or counter electrode layer 120 at end surface 80 of power generating layer 100 that is adjacent to current collector 50. Protruding portion 51, for example, is a region that is outward from the end surface of electrode layer 110 or counter electrode layer 120 at end surface 80 of power generating layer 100 that is adjacent to current collector 50, when viewed in the stacking direction of current collector 50. The end surface of electrode layer 110 or counter electrode layer 120 at end surface 80 of power generating layer 100 that is adjacent to current collector 50 is the end surface of the layer of power generating layer 100 that is closest to current collector 50. More specifically, the end surface of electrode layer 110 or counter electrode layer 120 at end surface 80 of power generating layer 100 that is adjacent to current collector 50 is the end surface of electrode layer 110 if current collector 50 is electrode current collector 61, or the end surface of counter electrode layer 120 if current collector 50 is counter electrode current collector 62.

Protruding portion 51 is bent. Protruding portion 51 may be curved. When side surface portion 11 is viewed from straight on in a direction parallel to the main surface of power generating layer 100, protruding portion 51 includes anchor portion 52 that extends beyond stacked portion 55 in a direction perpendicular to the main surface of power generating layer 100 (the z-axis direction in the illustrated example). When side surface portion 11 or 12 is viewed from the outside in a direction parallel to the main surface of power generating layer 100, anchor portion 52 includes a portion of protruding portion 51 that does not overlap stacked portion 55. Anchor portion 52 is formed by bending or curving protruding portion 51. Anchor portion 52 may extend in the positive direction of the z-axis, in the negative direction of the z-axis, or in both the positive and negative directions of the z-axis.

Protruding portion 51 is bent at one point inward of the center of protruding portion 51. The center of protruding portion 51 is the position where the distance to the boundary between protruding portion 51 and stacked portion 55 is the same as the distance to the leading end of protruding portion 51. The position and number of bends or curves in protruding portion 51 are not limited to this example. For example, current collector 50 may include protruding portion 51a that includes two bends or curves, such as protruding portion 51a illustrated in FIG. 1. For example, current collector 50 may include protruding portion 51b that is not bent or curved bur rather extends in the same direction as stacked portion 55, such as protruding portion 51b.

The main surfaces of protruding portion 51 are exposed when power generating element 5 is in a standalone state. This allows for connection to counter electrode terminal 31 or electrode terminal 32 at the main surfaces of protruding portion 51. The main surfaces of protruding portion 51 may be covered by electrode layer 110 or counter electrode layer 120. In such cases, the thickness of electrode layer 110 or counter electrode layer 120 is, for example, no more than one-fifth of the thickness of the portion of electrode layer 110 or counter electrode layer 120 stacked on stacked portion 55.

Stacked portion 55 is, for example, the region of current collector 50 that is located on the end surface 80 side of protruding portion 51, connected to protruding portion 51, and overlaps electrode layer 110 or counter electrode layer 120 of power generating layer 100 adjacent to current collector 50. The boundary between protruding portion 51 and stacked portion 55 is located at the end surface of electrode layer 110 or counter electrode layer 120 at end surface 80 of power generating layer 100 that is adjacent to current collector 50, when viewed in the stacking direction. In the present embodiment, in cases in which electrode layer 110 or counter electrode layer 120 thinly covers a main surface of protruding portion 51 as described above, the thinly covering end portion of electrode layer 110 or counter electrode layer 120 is not included in end surface 80.

As illustrated in FIG. 1, FIG. 3, and FIG. 4, when protruding portion 51 and stacked portion 55 are projected from outside side surface portion 11 in a direction parallel to the main surfaces of the plurality of power generating layers 100 onto virtual projection plane P1 perpendicular to the main surfaces of the plurality of power generating layers 100, projected area 51s of protruding portion 51 is larger than the projected area of stacked portion 55. In the examples illustrated in FIG. 1, FIG. 2, and FIG. 4, projection plane P1 is parallel to the z- and y-axes. Stated differently, projection plane P1 is perpendicular to the main surfaces of the plurality of power generating layers 100 and parallel to the direction of extension of side surface portion 11 in a direction parallel to the main surfaces of the plurality of power generating layers 100. The white arrows illustrated in FIG. 3 and FIG. 4 are one example of the projection direction. In the illustrated examples, the projection direction is parallel to the x-axis, i.e., perpendicular to projection plane P1.

As illustrated in FIG. 4, the projected area of stacked portion 55 is equal to the cross-sectional area of stacked portion 55 when cut in the thickness direction. However, protruding portion 51 includes anchor portion 52, which is formed by bending and extends beyond stacked portion 55. The projected area of stacked portion 55 can also be said to be the projected area of the region defined by the boundary of stacked portion 55 and protruding portion 51. Therefore, projected area 51s of protruding portion 51 is larger than the projected area of stacked portion 55 by the projected area of anchor portion 52. Stated differently, protruding portion 51 protrudes beyond end surface 80 so as to have a larger projected area than stacked portion 55.

Projected area 51s of protruding portion 51 being larger than the projected area of stacked portion 55 allows protruding portion 51 to bite into the terminal when connected to it, strengthening the mechanical connection between current collector 50 and the terminal due to the anchoring effect. When compared with a configuration in which the height from end surface 80 of power generating layer 100 to the leading end of protruding portion 51 is the same, the surface area of protruding portion 51 is larger than when projected area 51s of protruding portion 51 is the same as the projected area of stacked portion 55. As a result, the connection area when protruding portion 51 is connected to the terminal can be increased. Stated differently, the connection area when protruding portion 51 is connected to the terminal without increasing the size of battery 1 as a whole can be increased. This has the effect of reducing the electrical connection resistance and improving the mechanical connection strength between protruding portion 51 and the terminal. Since anchor portion 52 is formed by bending, it is easy to form protruding portion 51 having a large projected area 51s.

When protruding portion 51 is connected to an insulating component, the mechanical connection can be as strong as when it is connected to a terminal, thereby increasing the reliability of battery 1.

The maximum angle of a bend or curve in protruding portion 51 is, for example, 90 degrees or less with respect to stacked portion 55. This makes it possible to easily form counter electrode terminal 31 and electrode terminal 32. Also, the maximum angle of the bend or the curve included in protruding portion 51 may be between 1 and 45 degrees, inclusive, with respect to the stacked portion. This makes it possible to easily form counter electrode terminal 31 and electrode terminal 32, as well as enhance the mechanical connection strength with counter electrode terminal 31 and electrode terminal 32.

The length of the section of protruding portion 51 that is protruding beyond end surface 80 is, for example, at least twice the thickness of stacked portion 55. This means that when entire protruding portion 51 is connected to the terminal, the connection area is five times larger than when only the end surface of current collector 50 is connected to the terminal. Moreover, the high current characteristics of battery 1 can be enhanced. The length of the section of protruding portion 51 that is protruding beyond end surface 80 may be at least 4.5 times the thickness of stacked portion 55. This means that when entire protruding portion 51 is connected to the terminal, the connection area is ten times larger than when only the end surface of current collector 50 is connected to the terminal. More specifically, the length of the portion of protruding portion 51 protruding beyond end surface 80 is the shortest distance on the surface of protruding portion 51 from the position of the boundary between protruding portion 51 and stacked portion 55 to the leading end of protruding portion 51.

The height of the leading end of protruding portion 51 from end surface 80 of power generating layer 100 is, for example, less than or equal to the thickness of power generating element 5. This allows the terminal connection points in battery 1 to be downsized and increases the energy density of battery 1. The height of the leading end of protruding portion 51 from end surface 80 of power generating layer 100 may be less than or equal to twice the thickness of power generating layer 100 or less than or equal to the thickness of power generating layer 100. This allows the energy density of battery 1 to be further increased. To increase the connection strength and connection area with the terminal, the height of the leading end of protruding portion 51 from end surface 80 of power generating layer 100 is, for example, at least one-half the thickness of power generating layer 100. The height of the leading end of protruding portion 51 from end surface 80 of power generating layer 100 is, in the illustrated example, the maximum distance between end surface 80 of power generating layer 100 and the leading end of protruding portion 51 in the x-axis direction.

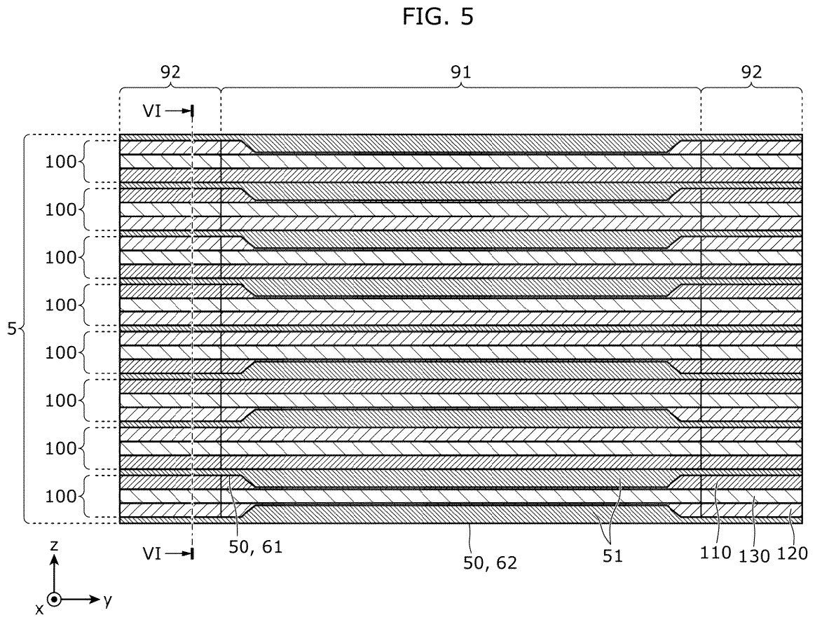

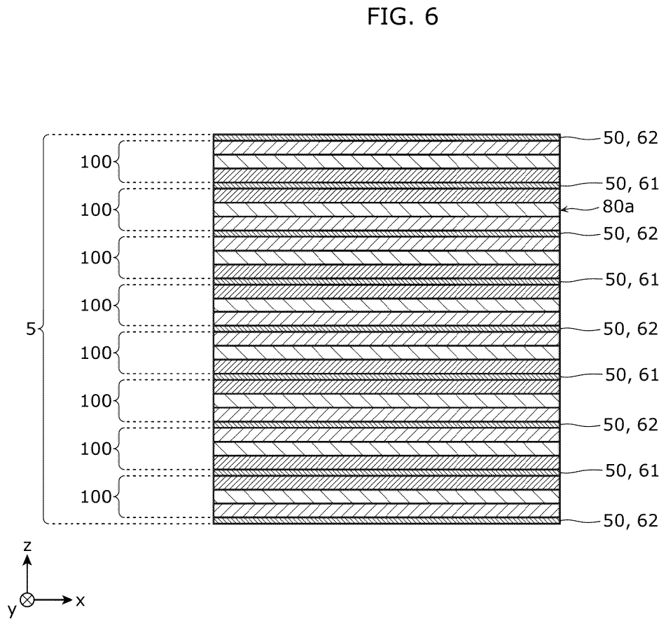

Next, the arrangement of protruding portions 51 in side surface portion 11 will be explained. FIG. 5 is a plan view of power generating element 5 of battery 1 according to the present embodiment when viewed from the side (positive x-axis direction). More specifically, FIG. 5 is a view looking straight on at side surface portion 11 of power generating element 5. FIG. 5 illustrates the same shape as when projected in the projection direction described above. FIG. 6 is a cross-sectional view of power generating element 5 of battery 1 according to the present embodiment. FIG. 6 is a cross-sectional view taken at a position where contiguous region 92 (to be described later) is cut. FIG. 6 illustrates a cross section taken at line VI-VI in FIG. 5. In FIG. 5, the end surfaces of each layer represented in side surface portion 11 are shaded with the same shading used in the cross section of FIG. 1. This is also true for the other plan views described below.

As illustrated in FIG. 5, side surface portion 11 includes protruding region 91 in which protruding portions 51 of current collectors 50 are provided, and contiguous regions 92 located on both sides of protruding region 91 in a direction parallel to the main surfaces of the plurality of power generating layers 100 in side surface portion 11. As illustrated in FIG. 6, contiguous region 92 is a region in which current collectors 50 do not protrude beyond end surfaces 80a of the plurality of power generating layers 100. In this way, providing contiguous regions 92 on both sides of protruding portions 51 allows both sides of protruding portions 51 to be supported by power generating layers 100, thereby moderately restricting the freedom of movement of protruding portions 51 and thus inhibiting movement of protruding portions 51. With this, in the manufacturing process of battery 1, etc., before the terminals are formed and while protruding portions 51 are still exposed, short circuits from contact between protruding portions 51 resulting from the exposed protruding portions 51 moving in the stacking direction can be inhibited. Even if no contact is made, a discharge short circuit may occur due to the proximity of protruding portions 51 to each other, but such a discharge short circuit can be inhibited for the same reasons.

In protruding region 91, each of the plurality of power generating layers 100 is receded from the plurality of current collectors 50 to form end surfaces 80 that are recessed relative to the plurality of current collectors 50. Therefore, in protruding region 91, a region void of power generating layer 100 is formed between adjacent current collectors 50.

In protruding region 91, each end surface 80, where each power generating layer 100 is receded, is aligned in the stacking direction (z-axis direction) of power generating element 5. This makes it easier to form protruding region 91.

In contiguous region 92, for example, when viewed from the z-axis direction, end surfaces 80a of each of the plurality of power generating layers 100—specifically, the end surfaces of electrode layer 110, solid electrolyte layer 130, and counter electrode layer 120 of each of the plurality of power generating layers 100—and the end surfaces of each of the plurality of current collectors 50 are flush. Therefore, in contiguous region 92, power generating layer 100 is present between adjacent current collectors 50. In contiguous region 92, for example, end surfaces 80a of each of the plurality of power generating layers 100 and the end surfaces of each of the plurality of current collectors 50 are contiguous and flush, forming a flat surface perpendicular to the main surfaces of the plurality of power generating layers 100. As used herein, the term “flat surface” means that the surface is substantially flat, and includes fine irregularities on the flat surface that may result from, for example, cutting the stacked body of the plurality of power generating layers 100 and the plurality of current collectors 50.

Contiguous region 92 is, for example, a region including the end portion, of side surface portion 11, that is located in a direction perpendicular to the stacking direction of power generating element 5. Accordingly, in the ridge portion of power generating element 5, power generating layer 100 is arranged on adjacent current collectors 50, inhibiting current collectors 50 from contacting each other in the ridge portion of power generating element 5, which is a portion highly susceptible to external forces. In contiguous region 92, since power generating layers 100 are arranged up to the same positions as the end surfaces of current collectors 50, the connection between current collectors 50 and the terminals in protruding region 91 can be ensured, and the volume of power generating layer 100 can be increased compared to when the entire side surface portion 11 is protruding region 91, which further increases the volumetric energy density of battery 1.

Side surface portion 12, for example, also includes protruding region 91 and contiguous regions 92, just like side surface portion 11. Side surface portion 13 and side surface portion 14, for example, do not include protruding region 91 and consist only of contiguous region 92, but may include protruding region 91 and contiguous region 92. The structures of side surface portion 11 and side surface portion 12 are not limited to when side surface portion 11 and side surface portion 12 are formed facing away from each other. For example, the structures of side surface portion 11 and side surface portion 12 may be formed on two adjacent (orthogonal) side surface portions, such as side surface portion 11 and side surface portion 13, instead of on side surface portion 11 and side surface portion 12.

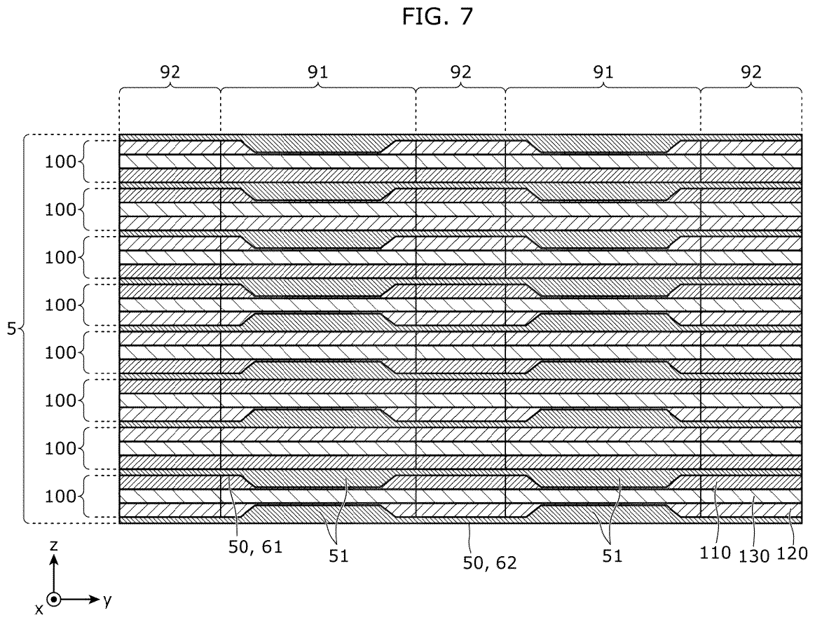

Note that side surface portion 11 and side surface portion 12 need not include contiguous region 92. Moreover, in side surface portion 11 and side surface portion 12, protruding region 91 may be separated into a plurality of regions by contiguous regions 92. FIG. 7 is another plan view of power generating element 5 of battery 1 according to the present embodiment when viewed from the side. FIG. 7 is a view looking straight on at side surface portion 11, just like FIG. 5. As illustrated in FIG. 7, in side surface portion 11, protruding region 91 is separated into two regions by contiguous regions 92. Protruding region 91 may be separated into three or more regions. Each of the plurality of separated protruding regions 91 is flanked on both sides by contiguous region 92 in a direction parallel to the main surfaces of the plurality of power generating layers 100 in side surface portion 11. This reduces the individual widths of protruding portions 51 in separated protruding regions 91, inhibiting movement of protruding portions 51. Protruding portions 51 are therefore further inhibited from moving and contacting each other during the manufacturing process of battery 1, thus inhibiting a short circuit.

Next, electrode insulating layer 21, counter electrode insulating layer 22, counter electrode terminal 31, and electrode terminal 32 will be described in detail.

Electrode insulating layer 21 is one example of an insulating component, and covers electrode layer 110 and electrode current collector 61 in side surface portion 11, as illustrated in FIG. 1. More specifically, electrode insulating layer 21 completely covers electrode current collector 61 and electrode layer 110 in side surface portion 11.

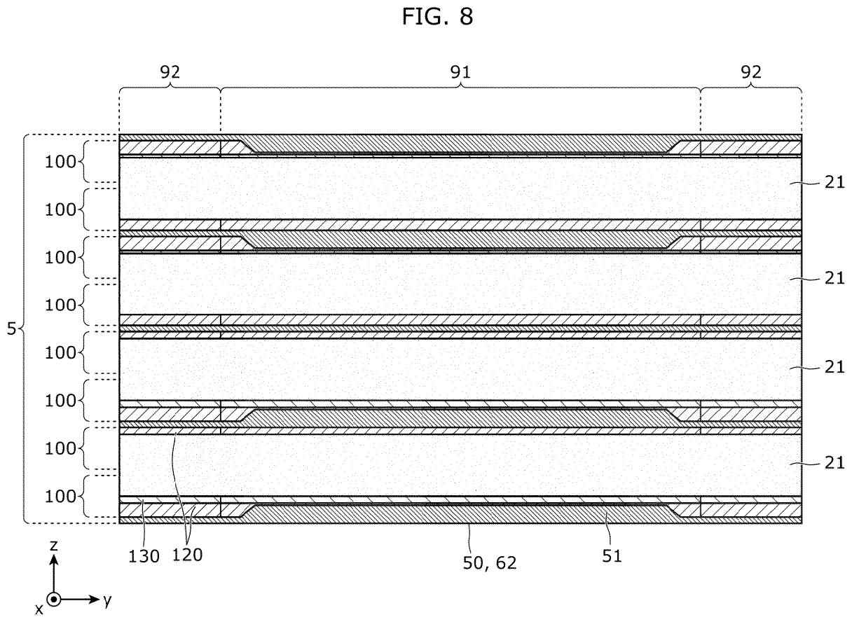

FIG. 8 is a plan view illustrating the positional relationship between side surface portion 11 of power generating element 5 according to the present embodiment and electrode insulating layers 21 on side surface portion 11.

FIG. 8 illustrates side surface portion 11 illustrated in FIG. 5 and electrode insulating layers 21 on side surface portion 11. Stated differently, FIG. 8 is a plan view of battery 1 in FIG. 1 in the positive direction of the x-axis, looking through counter electrode terminal 31.

As illustrated in FIG. 1 and FIG. 8, electrode insulating layer 21 covers electrode layer 110 of each of the plurality of power generating layers 100 in side surface portion 11. In side surface portion 11, with respect to each of the plurality of power generating layers 100, electrode insulating layer 21 covers electrode current collector 61, which is electrically connected to electrode layer 110. With respect to each of the plurality of power generating layers 100, electrode insulating layer 21 covers protruding portion 51 of electrode current collector 61, which is electrically connected to electrode layer 110. The main surfaces on both sides and the end surface of protruding portion 51 of electrode current collector 61 are covered by electrode insulating layer 21, and protruding portion 51 of electrode current collector 61 is completely buried in electrode insulating layer 21. This inhibits protruding portion 51 of electrode current collector 61 from contacting counter electrode current collector 62 and counter electrode terminal 31, etc., and from discharging in close proximity to counter electrode current collector 62 and counter electrode terminal 31. This inhibits the occurrence of a short circuit between electrode layer 110 and counter electrode layer 120.

In side surface portion 11, with respect to each of the plurality of power generating layers 100, electrode insulating layer 21 does not cover at least a portion of counter electrode layer 120. Electrode insulating layers 21 do not cover the plurality of counter electrode current collectors 62 in side surface portion 11. In the example illustrated in FIG. 8, throughout the entire side surface portion 11 spanning protruding region 91 and contiguous regions 92, electrode insulating layers 21 do not cover at least a portion of counter electrode layers 120 and do not cover counter electrode current collectors 62 of each of the plurality of power generating layers 100. Accordingly, electrode insulating layers 21 are formed in a stripe shape when side surface portion 11 is viewed straight on.

Electrode insulating layer 21 continuously covers electrode layers 110 of two adjacent power generating layers 100. More specifically, electrode insulating layer 21 continuously covers a region from at least a portion of solid electrolyte layer 130 of one of two adjacent power generating layers 100 to at least a portion of solid electrolyte layer 130 of the other of the two adjacent power generating layers 100. Electrode insulating layer 21 covers, for example, electrode layer 110, solid electrolyte layer 130, and electrode current collector 61 by contacting them.

Thus, in side surface portion 11, electrode insulating layer 21 covers at least a portion of solid electrolyte layer 130. More specifically, when side surface portion 11 is viewed straight on, the contour of electrode insulating layer 21 overlaps solid electrolyte layer 130. This reduces the risk of exposing electrode layer 110 even if the widths (lengths in the z-axis direction) of electrode insulating layers 21 differ due to manufacturing variations. This inhibits a short circuit between electrode layer 110 and counter electrode layer 120 via counter electrode terminal 31, which is formed to cover electrode insulating layer 21. In addition, the end surface of solid electrolyte layer 130, which is formed of powdery material, has very fine irregularities. Electrode insulating layer 21 interlocks with these irregularities, which improves the adhesion strength of electrode insulating layer 21 and improves insulation reliability.

In the present embodiment, electrode insulating layer 21 may cover all of solid electrolyte layer 130 in side surface portion 11. More specifically, the contour of electrode insulating layer 21 may overlap the boundary between solid electrolyte layer 130 and counter electrode layer 120. Electrode insulating layer 21 is not required to cover part of solid electrolyte layer 130. For example, the contour of electrode insulating layer 21 may overlap the boundary between solid electrolyte layer 130 and electrode layer 110. Also, in side surface portion 11, electrode insulating layer 21 may cover not only electrode layer 110, but also all of solid electrolyte layer 130 and at least a portion of counter electrode layer 120.

As illustrated in FIG. 1, counter electrode insulating layer 22 covers counter electrode layer 120 in side surface portion 12. More specifically, counter electrode insulating layer 22 completely covers counter electrode current collector 62 and counter electrode layer 120 in side surface portion 12.

Counter electrode insulating layer 22 covers counter electrode layer 120 of each of the plurality of power generating layers 100 in side surface portion 12. In side surface portion 12, with respect to each of the plurality of power generating layers 100, counter electrode insulating layer 22 covers counter electrode current collector 62, which is electrically connected to counter electrode layer 120. With respect to each of the plurality of power generating layers 100, counter electrode insulating layer 22 covers protruding portion 51 of counter electrode current collector 62, which is electrically connected to counter electrode layer 120. The main surfaces on both sides and the end surface of protruding portion 51 of counter electrode current collector 62 are covered by counter electrode insulating layer 22, and protruding portion 51 of counter electrode current collector 62 is completely buried in counter electrode insulating layer 22. This inhibits protruding portion 51 of counter electrode current collector 62 from contacting electrode current collector 61 and electrode terminal 32, etc., and from discharging in close proximity to electrode current collector 61 and electrode terminal 32.

In side surface portion 12, with respect to each of the plurality of power generating layers 100, counter electrode insulating layer 22 does not cover at least a portion of electrode layer 110. Counter electrode insulating layer 22 does not cover electrode current collector 61 in side surface portion 12. For example, throughout the entire side surface portion 12, with respect to each of the plurality of power generating layers 100, counter electrode insulating layer 22 does not cover at least a portion of electrode layer 110 and does not cover the plurality of electrode current collectors 61. Therefore, counter electrode insulating layers 22 are formed in a stripe shape when side surface portion 12 is viewed straight on (specifically, when viewed from the negative direction of the x-axis in the present embodiment), just like electrode insulating layers 21 illustrated in FIG. 8.

Counter electrode insulating layer 22 continuously covers counter electrode layers 120 of two adjacent power generating layers 100. More specifically, counter electrode insulating layer 22 continuously covers a region from at least a portion of solid electrolyte layer 130 of one of two adjacent power generating layers 100 to at least a portion of solid electrolyte layer 130 of the other of the two adjacent power generating layers 100. Counter electrode insulating layer 22 covers, for example, counter electrode layer 120, solid electrolyte layer 130, and counter electrode current collector 62 by contacting them.

Thus, in side surface portion 12, counter electrode insulating layer 22 covers at least a portion of solid electrolyte layer 130. More specifically, when side surface portion 12 is viewed straight on, the contour of counter electrode insulating layer 22 overlaps solid electrolyte layer 130. This reduces the risk of exposing counter electrode layer 120 even if the widths (lengths in the z-axis direction) of counter electrode insulating layers 22 differ due to manufacturing variations. This inhibits a short circuit between counter electrode layer 120 and electrode layer 110 via electrode terminal 32, which is formed to cover counter electrode insulating layer 22. Counter electrode insulating layer 22 interlocks with the irregularities on the end surface of solid electrolyte layer 130, which improves the adhesion strength of counter electrode insulating layer 22 and improves insulation reliability.

In the present embodiment, counter electrode insulating layer 22 may cover all of solid electrolyte layer 130 in side surface portion 12. More specifically, the contour of counter electrode insulating layer 22 may overlap the boundary between solid electrolyte layer 130 and electrode layer 110. Counter electrode insulating layer 22 is not required to cover part of solid electrolyte layer 130. For example, the contour of counter electrode insulating layer 22 may overlap the boundary between solid electrolyte layer 130 and counter electrode layer 120. Also, in side surface portion 12, counter electrode insulating layer 22 may cover not only counter electrode layer 120, but also all of solid electrolyte layer 130 and at least a portion of electrode layer 110.

In power generating element 5 according to the present embodiment, the top-most and bottom-most current collectors 50 are counter electrode current collectors 62. As illustrated in FIG. 1, in the vicinity of the top and bottom edges of side surface portion 12, counter electrode insulating layers 22 partially cover the main surfaces (i.e., main surfaces 15 and 16) of the top-most and bottom-most counter electrode current collectors 62. As a result, counter electrode insulating layer 22 is resistant to external forces, such as those from the z-axis direction, inhibiting detachment. Even if electrode terminal 32 wraps around main surfaces 15 and 16 of power generating element 5, it can contact counter electrode current collectors 62 and prevent a short circuit from occurring. Thus, the reliability of battery 1 can be enhanced by employing a configuration in which counter electrode insulating layer 22 covers a portion of main surfaces 15 and 16.

Electrode insulating layers 21 and counter electrode insulating layers 22 are formed using electrically insulating materials. For example, electrode insulating layers 21 and counter electrode insulating layers 22 each include resin. Resin is, for example, but not limited to, epoxy resin. An inorganic material may be used as the insulating material. Available insulating materials are selected based on various properties such as flexibility, gas barrier, impact resistance, and heat resistance. Electrode insulating layers 21 and counter electrode insulating layers 22 are formed using the same material as each other, but may be formed using different materials.

As illustrated in FIG. 1, counter electrode terminal 31 is one example of a conductive component that covers side surface portion 11 and electrode insulating layers 21, and is electrically connected to counter electrode layers 120 directly and through counter electrode current collectors 62. More specifically, counter electrode terminal 31 covers electrode insulating layers 21 and the portions of side surface portion 11 that are not covered by electrode insulating layers 21.

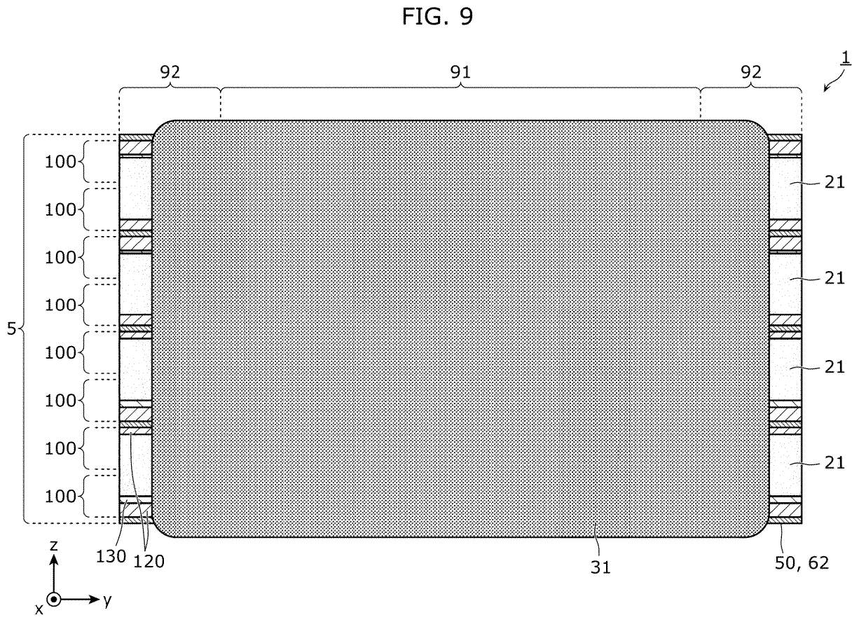

FIG. 9 is a plan view illustrating the positional relationship between side surface portion 11 of power generating element 5 according to the present embodiment and electrode insulating layer 21 and counter electrode terminal 31 on side surface portion 11. FIG. 9 is a plan view of battery 1 in FIG. 1 when viewed from the positive direction of the x-axis.

In the portions of side surface portion 11 that are not covered by electrode insulating layers 21, the end portions of counter electrode current collectors 62 and the end portions of counter electrode layers 120 are exposed, as illustrated in FIG. 8. Thus, as illustrated in FIG. 1 and FIG. 9, counter electrode terminal 31 contacts the end portions of counter electrode current collectors 62 and the end portions of counter electrode layers 120, and is electrically connected to counter electrode layers 120.

More specifically, counter electrode terminal 31 is connected to protruding portions 51 of counter electrode current collectors 62. For example, counter electrode terminal 31 covers the main surfaces on both sides and the end surfaces of protruding portions 51 of counter electrode current collectors 62. Protruding portions 51 of counter electrode current collectors 62 are completely buried in counter electrode terminal 31. Counter electrode terminal 31 may be connected to only one of the main surfaces on both sides of protruding portion 51.

At end surfaces 80 of power generating layers 100, counter electrode terminal 31 contacts and covers the end surfaces of counter electrode layers 120 disposed adjacent to counter electrode current collectors 62. Counter electrode layer 120 is formed of a powdery material and, like solid electrolyte layer 130, has very fine irregularities. Counter electrode terminal 31 interlocks with the irregularities on the end surface of counter electrode layer 120, which improves the connection strength of counter electrode terminal 31 and improves the reliability of the electrical connection. Counter electrode terminal 31 is connected to the main surfaces of protruding portions 51 of counter electrode current collectors 62 and the end surfaces of counter electrode layers 120, and no void is formed between protruding portions 51 and the end surfaces of counter electrode layers 120. Therefore, counter electrode terminal 31 can improve the mechanical strength of battery 1 by holding protruding portions 51 stably in place by inhibiting protruding portions 51 from wobbling, which they tend to do due to their large projected area. Note that a void may be formed between protruding portions 51 and the end surfaces of counter electrode layers 120. For example, the boundaries between protruding portions 51 and counter electrode layers 120 at end surfaces 80 may not be in contact with counter electrode terminal 31 and a void may be formed over these boundaries. Even in such cases, counter electrode terminal 31 contacting the end surfaces of counter electrode layers 120 still achieves the advantageous effect of stably holding protruding portions 51.

With respect to each of the plurality of power generating layers 100, counter electrode terminal 31 is electrically connected to counter electrode current collector 62, which is electrically connected to counter electrode layer 120. This gives each counter electrode current collector 62 the same potential as counter electrode terminal 31. As a result, counter electrode terminal 31 is electrically connected to each counter electrode layer 120 of the plurality of power generating layers 100. Stated differently, counter electrode terminal 31 serves to electrically connect each power generating layer 100 in parallel.

As illustrated in FIG. 1 and FIG. 9, counter electrode terminal 31 covers almost the entire side surface portion 11 from the bottom to the top.

In power generating element 5 according to the present embodiment, the top-most and bottom-most current collectors 50 are counter electrode current collectors 62. As illustrated in FIG. 1, at the top and bottom edges of side surface portion 11, counter electrode terminal 31 partially covers a portion of the main surfaces, namely, main surfaces 15 and 16 of power generating element 5, of top-most and bottom-most counter electrode current collectors 62. As a result, counter electrode terminal 31 is resistant to external forces, such as those from the z-axis direction, inhibiting detachment. Since the connection area between counter electrode terminal 31 and counter electrode current collectors 62 is larger, the connection resistance between counter electrode terminal 31 and counter electrode current collectors 62 is lower, which improves the high current characteristics. For example, this enables rapid recharging of battery 1. Note that in configurations in which the top-most and bottom-most current collectors 50 are electrode current collectors 61, counter electrode terminal 31 may cover main surfaces 15 and 16 via an insulating layer covering electrode current collectors 61.

As illustrated in FIG. 9, counter electrode terminal 31 may cover counter electrode current collectors 62 and counter electrode layers 120 in contiguous regions 92.

As illustrated in FIG. 1, electrode terminal 32 is one example of a conductive component that covers side surface portion 12 and counter electrode insulating layers 22, and is electrically connected to electrode layers 110 directly and through electrode current collectors 61. More specifically, electrode terminal 32 covers counter electrode insulating layers 22 and the portions of side surface portion 12 that are not covered by counter electrode insulating layers 22.

In the portions of side surface portion 12 that are not covered by counter electrode insulating layers 22, the end portions of electrode current collectors 61 and the end portions of electrode layers 110 are exposed. Thus, as illustrated in FIG. 1, electrode terminal 32 contacts the end portions of electrode current collectors 61 and the end portions of electrode layers 110, and is electrically connected to electrode layers 110.

More specifically, electrode terminal 32 is connected to protruding portions 51 of electrode current collectors 61. For example, electrode terminal 32 covers the main surfaces on both sides and the end surfaces of protruding portions 51 of electrode current collectors 61. Protruding portions 51 of electrode current collectors 61 are completely buried in electrode terminal 32. Electrode terminal 32 may be connected to only one of the main surfaces on both sides of protruding portion 51.

At end surfaces 80 of power generating layers 100, electrode terminal 32 contacts and covers the end surfaces of electrode layers 110 adjacent to electrode current collectors 61. Electrode layer 110 is formed of a powdery material and, like solid electrolyte layer 130, has very fine irregularities. Electrode terminal 32 interlocks with the irregularities on the end surface of electrode layer 110, which improves the adhesion strength of electrode terminal 32 and improves the reliability of the electrical connection. Electrode terminal 32 is connected to the main surfaces of protruding portions 51 of electrode current collectors 61 and the end surfaces of electrode layers 110, and no void is formed between protruding portions 51 and the end surfaces of electrode layers 110. Therefore, electrode terminal 32 can improve the mechanical strength of battery 1 by holding protruding portions 51 stably in place by inhibiting protruding portions 51 from wobbling, which they tend to do due to their large projected area. Note that a void may be formed between protruding portions 51 and the end surfaces of electrode layers 110. For example, the boundaries between protruding portions 51 and electrode layers 110 at end surfaces 80 may not be in contact with electrode terminal 32 and a void may be formed over these boundaries. Even in such cases, electrode terminal 32 contacting the end surfaces of electrode layers 110 still achieves the advantageous effect of stably holding protruding portions 51.

With respect to each of the plurality of power generating layers 100, electrode terminal 32 is electrically connected to electrode current collector 61, which is electrically connected to electrode layer 110. This gives each electrode current collector 61 the same potential as electrode terminal 32. As a result, electrode terminal 32 is electrically connected to each electrode layer 110 of the plurality of power generating layers 100. Stated differently, electrode terminal 32 serves to electrically connect each power generating layer 100 in parallel.

As illustrated in FIG. 1, electrode terminal 32 covers almost entire side surface portion 12 from the bottom to the top.

Similarly to counter electrode terminal 31 explained with reference to FIG. 9, electrode terminal 32 may cover electrode current collectors 61 and electrode layers 110 in contiguous regions 92.

Counter electrode terminal 31 and electrode terminal 32 are formed using a conductive resin material or the like. The conductive resin material includes, for example, a resin and a conductive material of metal particles or the like filled in the resin. Alternatively, counter electrode terminal 31 and electrode terminal 32 may be formed using a metallic material such as solder. Available conductive materials are selected based on various properties such as flexibility, gas barrier, impact resistance, heat resistance, and solder wettability. Counter electrode terminal 31 and electrode terminal 32 are formed using the same material as each other, but may be formed using different materials.

External electrodes may be further formed on counter electrode terminal 31 and electrode terminal 32 by some other method such as plating, printing, or soldering. The formation of external electrodes can, for example, improve the mountability of battery 1.

As described above, battery 1 includes: power generating element 5 having a stacked structure of a plurality of power generating layers 100 and a plurality of current collectors 50; and counter electrode terminal 31. At least one of the plurality of current collectors 50 includes: protruding portion 51 that protrudes beyond end surface 80 of power generating layer 100 in side surface portion 11; and stacked portion 55, which is a region where power generating layer 100 is stacked. When protruding portion 51 and stacked portion 55 are projected onto projection plane P1, projected area 51s of protruding portion 51 is larger than the projected area of stacked portion 55. Counter electrode terminal 31 is connected to protruding portions 51 and contacts the end surfaces of counter electrode layers 120 disposed adjacent to the above-described at least one current collector 50 in side surface portion 11.

As a result, since protruding portion 51 protrudes beyond end surfaces 80 of power generating layers 100, counter electrode terminal 31 can be connected to the main surfaces of protruding portion 51 to draw out current. Therefore, compared to connecting a terminal to the end surface of current collector 50, the connection area between counter electrode terminal 31 and current collector 50 can be increased and the resistance of the connection area can be reduced, thus inhibiting voltage drop and heat generation at the connection area and enhancing high current characteristics. In addition, the increased connection area between counter electrode terminal 31 and current collector 50 increases the mechanical connection strength between counter electrode terminal 31 and current collector 50, thereby enhancing the reliability of battery 1. Moreover, by counter electrode terminal 31 being in contact with counter electrode layer 120, the reliability of the electrical connection of battery 1 improves, and the mechanical strength of battery 1 also improves since protruding portion 51 is stably held by counter electrode terminal 31.

Furthermore, projected area 51s of protruding portion 51 is larger than the projected area of stacked portion 55, resulting in a structure in which protruding portion 51 extends beyond stacked portion 55 in the stacking direction. Therefore, when protruding portion 51 is connected to counter electrode terminal 31, protruding portion 51 can bite into counter electrode terminal 31, and the mechanical connection between current collector 50 and counter electrode terminal 31 can be strengthened by the anchoring effect. When compared with a configuration in which the height from end surface 80 of power generating layer 100 to the leading end of protruding portion 51 is the same, the area of the main surface of protruding portion 51 is larger than when projected area 51s of protruding portion 51 is the same as the projected area of stacked portion 55. As a result, the connection area when counter electrode terminal 31 is connected to the main surface of protruding portion 51 can be increased. Stated differently, the connection area when counter electrode terminal 31 is connected to the main surface of protruding portion 51 without increasing the size of battery 1 as a whole can be increased. Therefore, a high-performance battery 1 with enhanced reliability, energy density, and high current characteristics can be realized.

In battery 1, counter electrode terminal 31 and electrode terminal 32 each serve the function of connecting the plurality of power generating layers 100 in parallel. As illustrated in FIG. 1, counter electrode terminal 31 and electrode terminal 32 are formed to closely cover electrode insulating layers 21 and counter electrode insulating layers 22 of power generating element 5 as well as side surface portions 11 and 12, thus lowering the height of the terminals in side surface portions 11 and 12 and reducing their volume. Stated differently, the energy density per volume of battery 1 can be improved because the volume of the terminals is smaller than when the terminals are formed by extending, joining, or crimping the protruding current collectors.

### [Variation]

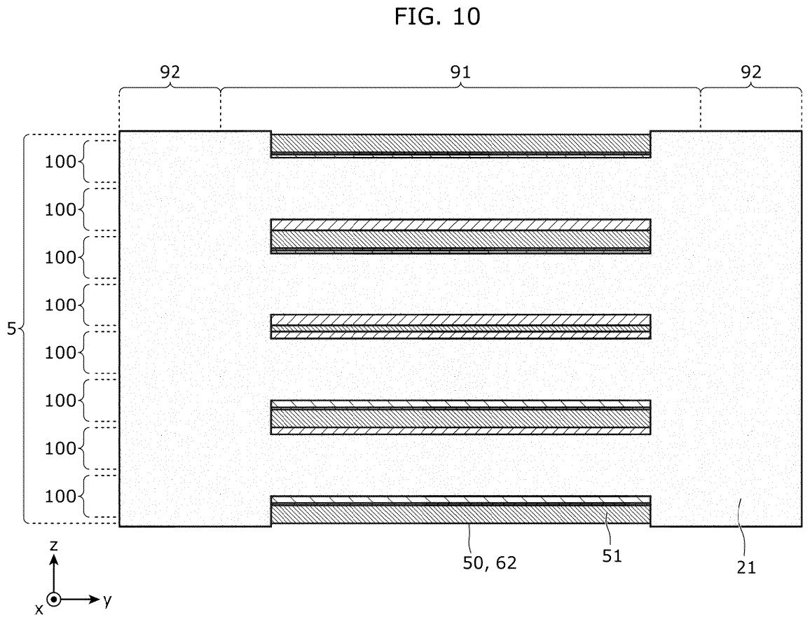

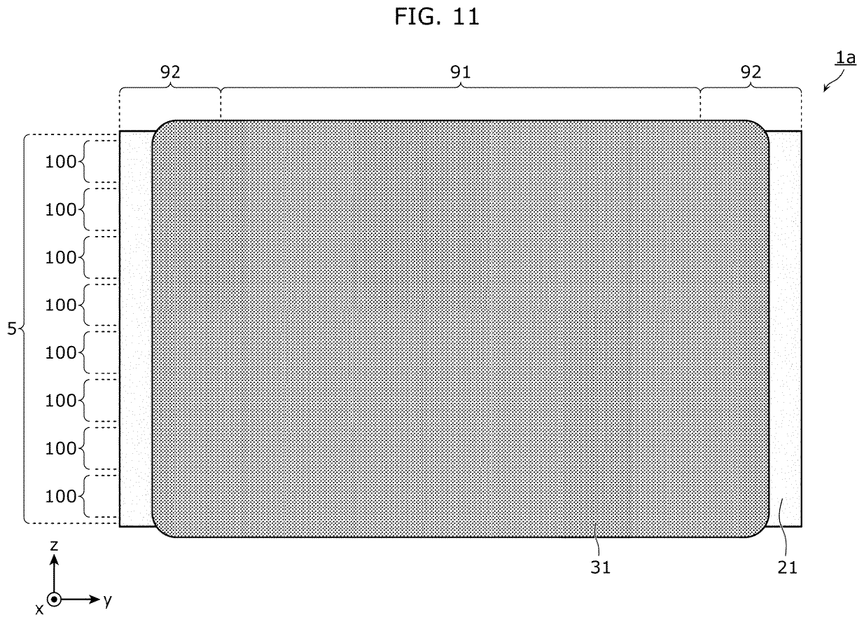

In the example illustrated in FIG. 8 described above, separate electrode insulating layers 21 are provided per two adjacent electrode layers 110 and electrode current collector 61 provided therebetween, but this example is non-limiting. For example, in addition to the stripe-shaped portion, electrode insulating layers 21 may be provided at the y-axis direction end portions of side surface portion 11, extending in the z-axis direction. FIG. 10 is a plan view illustrating the positional relationship between side surface portion 11 of power generating element 5 according to a variation of Embodiment 1 and electrode insulating layers 21 on side surface portion 11. FIG. 10 illustrates side surface portion 11 illustrated in FIG. 5 and electrode insulating layers 21 on side surface portion 11. FIG. 11 is a plan view of battery 1a according to a variation of Embodiment 1 when viewed from the side (positive x-axis direction). FIG. 10 is a plan view of battery 1a in FIG. 11 in the positive direction of the x-axis, looking through counter electrode terminal 31. Battery 1a illustrated in FIG. 11 includes the same power generating element 5 as battery 1, but differs from battery 1 in regard to the shapes of electrode insulating layer 21 and counter electrode terminal 31.

As illustrated in FIG. 10, electrode insulating layer 21 according to the present variation covers the entirety of contiguous regions 92 positioned on both sides of protruding region 91 in side surface portion 11. Stated differently, electrode insulating layer 21 according to the present variation is ladder-shaped when side surface portion 11 is viewed straight on. In this way, electrode insulating layer 21 may partially cover counter electrode current collectors 62. Note that electrode insulating layer 21 does not need to cover part of contiguous regions 92.

In the present variation, in a portion of protruding region 91 in side surface portion 11, electrode insulating layer 21 is provided continuously in the z-axis direction. Stated differently, electrode insulating layer 21 also partially covers counter electrode current collectors 62 in protruding region 91 in side surface portion 11.

As shown in FIG. 11, counter electrode terminal 31 in present variation covers electrode insulating layers 21 and all the portions of side surface portion 11 that are not covered by electrode insulating layers 21. Stated differently, in battery 1a, side surface portion 11 is entirely covered by at least one of electrode insulating layer 21 or counter electrode terminal 31, and is not exposed.

In this way, in battery 1a, counter electrode layers 120 and counter electrode current collectors 62 are covered by electrode insulating layer 21 in contiguous regions 92 where counter electrode current collectors 62 can only form electrical connections at the end surfaces, thereby inhibiting the degradation of high current characteristics and inhibiting the collapse and short circuit of power generating layers 100 in contiguous regions 92, thus increasing reliability.

Although not shown in the figures, in side surface portion 12 as well, counter electrode insulating layer 22 may be provided at the y-axis direction end portions of side surface portion 12, extending in the z-axis direction, just like electrode insulating layer 21 on the side surface portion 11 side. Stated differently, counter electrode insulating layer 22 may be ladder-shaped when side surface portion 12 is viewed straight on.

### Embodiment 2

Next, Embodiment 2 will be described. Hereinafter, description will focus on the differences from Embodiment 1 and description of common points may be omitted or simplified.

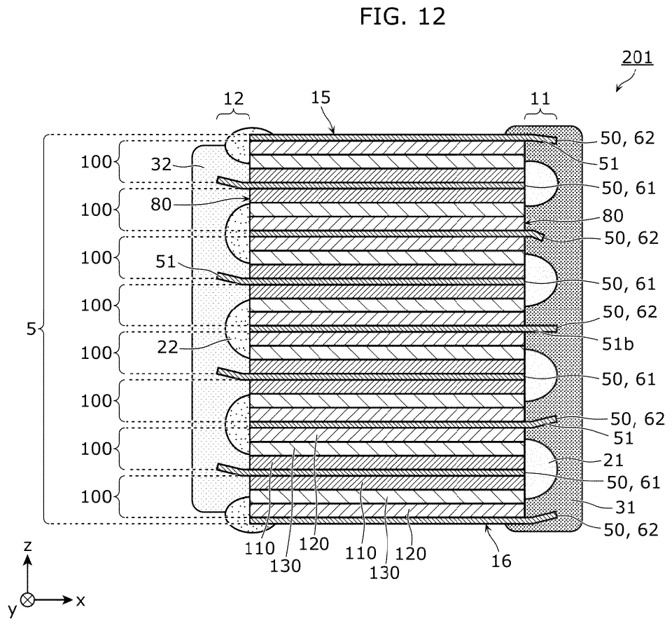

FIG. 12 is a cross-sectional view of battery 201 according to Embodiment 2. As illustrated in FIG. 12, battery 201 according to the present embodiment differs from battery 1 according to Embodiment 1 in that, of electrode current collectors 61 and counter electrode current collectors 62, only counter electrode current collectors 62 protrude in side surface portion 11 and only electrode current collectors 61 protrude in side surface portion 12.

In battery 201, in side surface portion 11, each counter electrode current collector 62 protrudes beyond end surfaces 80 of power generating layers 100, and each electrode current collector 61 does not protrude beyond end surfaces 80 of power generating layers 100. Stated differently, each counter electrode current collector 62 includes, in side surface portion 11, protruding portion 51 that protrudes beyond end surface 80. Furthermore, each electrode current collector 61 does not include a protruding portion that protrudes beyond end surface 80 in side surface portion 11. For example, in side surface portion 11, when viewed in the z-axis direction, the end surface of an electrode current collector 61 is flush with end surface 80 of the power generating layer 100 adjacent to the electrode current collector 61. Thus, because electrode current collectors 61, which are not connected to counter electrode terminal 31, do not protrude in side surface portion 11, electrode current collectors 61 and counter electrode current collectors 62 are inhibited from contacting and short-circuiting during the manufacturing process, for example.

In battery 201, in side surface portion 12, each electrode current collector 61 protrudes beyond end surfaces 80 of power generating layers 100, and each counter electrode current collector 62 does not protrude beyond end surfaces 80 of power generating layers 100. Stated differently, each electrode current collector 61 includes, in side surface portion 12, protruding portion 51 that protrudes beyond end surface 80. Furthermore, each counter electrode current collector 62 does not include a protruding portion that protrudes beyond end surface 80 in side surface portion 12. For example, in side surface portion 12, when viewed in the z-axis direction, the end surface of an counter electrode current collector 62 is flush with end surface 80 of the power generating layer 100 adjacent to the counter electrode current collector 62. Thus, because counter electrode current collectors 62, which are not connected to electrode terminal 32, do not protrude in side surface portion 12, electrode current collectors 61 and counter electrode current collectors 62 are inhibited from contacting and short-circuiting during the manufacturing process, for example.

Electrode insulating layer 21 covers electrode current collector 61 and electrode layer 110 in side surface portion 11, and is in contact with electrode current collector 61 and electrode layer 110. More specifically, in side surface portion 11, electrode insulating layer 21 continuously covers the end surface of electrode current collector 61 and the end surface of electrode layer 110 adjacent to electrode current collector 61. In battery 201, electrode insulating layers 21 can be easily formed because the end surfaces of electrode current collectors 61 and end surfaces 80 of power generating layers 100 are aligned and flush. Since electrode current collectors 61 do not protrude from electrode insulating layers 21, electrode current collectors 61 and counter electrode terminal 31 contacting and causing a short circuit can be inhibited.

Counter electrode insulating layer 22 covers counter electrode current collector 62 and counter electrode layer 120 in side surface portion 12, and is in contact with counter electrode current collector 62 and counter electrode layer 120. More specifically, in side surface portion 12, counter electrode insulating layer 22 continuously covers the end surface of counter electrode current collector 62 and the end surface of counter electrode layer 120 adjacent to counter electrode current collector 62. In battery 201, counter electrode insulating layers 22 can be easily formed because the end surfaces of counter electrode current collectors 62 and end surfaces 80 of power generating layers 100 are aligned and flush. Since counter electrode current collectors 62 do not protrude from counter electrode insulating layers 22, counter electrode current collectors 62 and electrode terminal 32 contacting and causing a short circuit can be inhibited.

### Embodiment 3

Next, Embodiment 3 will be described. Hereinafter, description will focus on the differences from Embodiments 1 and 2 and description of common points may be omitted or simplified.

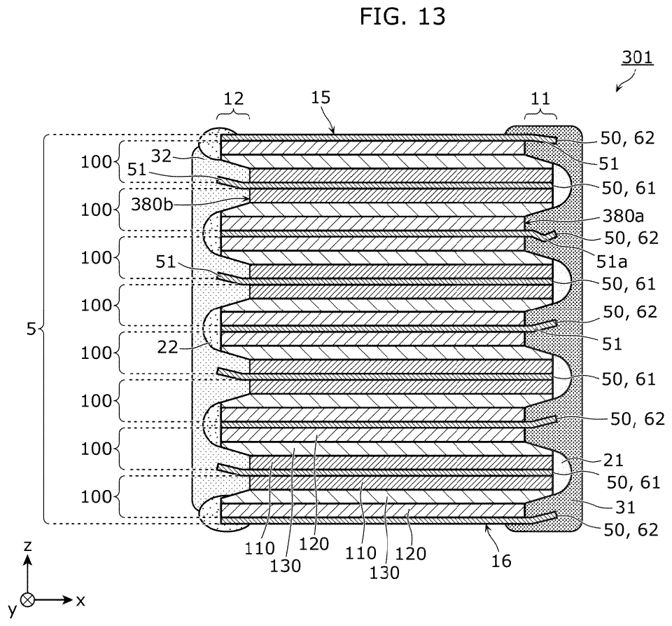

FIG. 13 is a cross-sectional view of battery 301 according to Embodiment 3. As illustrated in FIG. 13, battery 301 according to the present embodiment differs from battery 201 according to Embodiment 2 in that each of the plurality of power generating layers 100 includes, instead of end surface 80, end surface 380a where counter electrode layer 120 is receded from electrode layer 110 and end surface 380b where electrode layer 110 is receded from counter electrode layer 120.

In battery 301, in side surface portion 11, each power generating layer 100 includes end surface 380a where the end surface of counter electrode layer 120 is receded from the end surface of electrode layer 110. In side surface portion 11, only counter electrode layers 120 and solid electrolyte layers 130 of power generating layers 100 are receded from counter electrode current collectors 62. Each counter electrode current collector 62 includes, in side surface portion 11, protruding portion 51 that protrudes beyond end surface 380a. More specifically, in side surface portion 11, protruding portion 51 of each counter electrode current collector 62 protrudes beyond the end surfaces of counter electrode layers 120 defining end surfaces 380a. Stated differently, counter electrode current collector 62 includes, in side surface portion 11, protruding portion 51 that protrudes beyond end surface 380a. At end surface 380a, at least a portion of solid electrolyte layer 130 is receded from electrode layer 110. More specifically, the portion of the end surface of solid electrolyte layer 130 that is not covered by electrode insulating layer 21 is inclined oblique to the z-axis direction. Note that at end surface 380a, solid electrolyte layer 130 does not have to be receded from electrode layer 110.

In side surface portion 11, when viewed in the z-axis direction, the end surface of electrode current collector 61 is flush with the end surface of the electrode layer 110 adjacent to electrode current collector 61 among end surfaces 380a. Therefore, each electrode current collector 61 does not include a protruding portion that protrudes beyond end surface 380a in side surface portion 11. Thus, because electrode current collectors 61 do not protrude in side surface portion 11, electrode current collectors 61 and counter electrode current collectors 62 are inhibited from contacting and short-circuiting during the manufacturing process, for example.

For example, the entirety of electrode current collector 61 is sandwiched between electrode layers 110 in side surface portion 11 so as to hold electrode current collector 61 firmly in place. This makes it easy to bend or curve only those current collectors 50 that are connected to counter electrode terminal 31, i.e., only counter electrode current collectors 62. This inhibits current collectors 61 from deforming and contacting counter electrode current collectors 62 when bending or curving counter electrode current collectors 62.

Also, in side surface portion 12, each power generating layer 100 includes end surface 380b where the end surface of electrode layer 110 is receded from the end surface of counter electrode layer 120. In side surface portion 12, only electrode layers 110 and solid electrolyte layers 130 of power generating layers 100 are receded from electrode current collectors 61. Each electrode current collector 61 includes, in side surface portion 12, protruding portion 51 that protrudes beyond end surface 380b. More specifically, in side surface portion 12, protruding portion 51 of each electrode current collector 61 protrudes beyond the end surfaces of electrode layers 110 defining end surfaces 380b. In other words, electrode current collector 61 includes, in side surface portion 12, protruding portion 51 that protrudes beyond end surface 380b. At end surface 380b, at least a portion of solid electrolyte layer 130 is receded from counter electrode layer 120. More specifically, the portion of the end surface of solid electrolyte layer 130 that is not covered by counter electrode insulating layer 22 is inclined oblique to the z-axis direction. Note that at end surface 380b, solid electrolyte layer 130 does not have to be receded from counter electrode layer 120.

In side surface portion 12, when viewed in the z-axis direction, the end surface of counter electrode current collector 62 is flush with the end surface of counter electrode layer 120 adjacent to counter electrode current collector 62 among end surfaces 380b. Therefore, each counter electrode current collector 62 does not include a protruding portion that protrudes beyond end surface 380b in side surface portion 12. Thus, because counter electrode current collectors 62 do not protrude in side surface portion 12, electrode current collectors 61 and counter electrode current collectors 62 are inhibited from contacting during and short-circuiting the manufacturing process, for example.

For example, the entirety of counter electrode current collector 62 is sandwiched between counter electrode layers 120 in side surface portion 12 so as to hold counter electrode current collector 62 firmly in place. This makes it easy to bend or curve only those current collectors 50 that are connected to electrode terminal 32, i.e., only electrode current collectors 61. This inhibits counter electrode current collectors 62 from deforming and contacting electrode current collectors 61 when bending or curving electrode current collectors 61.

Electrode insulating layer 21 covers electrode current collector 61 and electrode layer 110 in side surface portion 11, and is in contact with electrode current collector 61 and electrode layer 110. More specifically, in side surface portion 11, electrode insulating layer 21 continuously covers the end surfaces of electrode current collectors 61 and the regions of end surfaces 380a of power generating layers 100 adjacent to electrode current collectors 61 that are not receded from electrode current collector 61.

Counter electrode insulating layer 22 covers counter electrode current collector 62 and counter electrode layer 120 in side surface portion 12, and is in contact with counter electrode current collector 62 and counter electrode layer 120. More specifically, in side surface portion 12, counter electrode insulating layer 22 continuously covers the end surfaces of counter electrode current collectors 62 and the regions of end surfaces 380b of power generating layers 100 adjacent to counter electrode current collectors 62 that are not receded from counter electrode current collector 62.

For example, after forming electrode insulating layers 21 and counter electrode insulating layers 22 on side surface portions 11 and 12, respectively, side surface portions 11 and 12 are processed in various ways to recede electrode layers 110, counter electrode layers 120, and solid electrolyte layers 130 that are not covered by electrode insulating layers 21 and counter electrode insulating layers 22, and cause current collectors 50 to relatively protrude. In this process, a portion of electrode insulating layers 21 and counter electrode insulating layers 22 are shaved off, slightly reducing the thicknesses of electrode insulating layers 21 and counter electrode insulating layers 22, and electrode layers 110 and counter electrode layers 120, which are made of powder material, recede at a higher speed than current collectors 50, resulting in current collectors 50 protruding. The manufacturing process can therefore be simplified because electrode insulating layers 21 and counter electrode insulating layers 22 can be formed on side surface portions 11 and 12 while still flat before protruding current collectors 50.

### Embodiment 4

Next, Embodiment 4 will be described. Hereinafter, description will focus on the differences from Embodiments 1 through 3 and description of common points may be omitted or simplified.

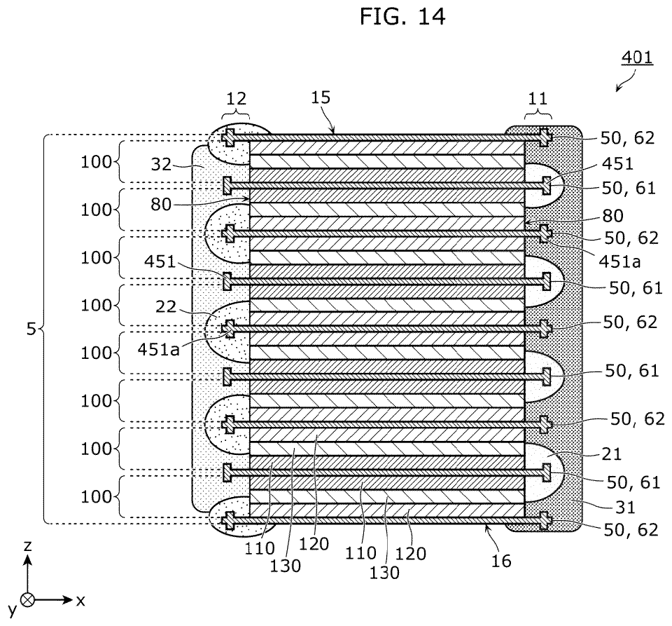

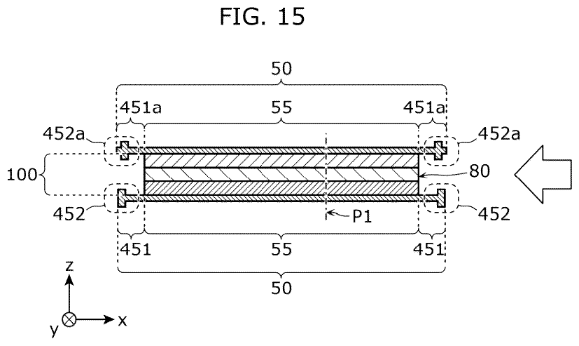

FIG. 14 is a cross-sectional view of battery 401 according to Embodiment 4. FIG. 15 is a cross-sectional view for explaining the detailed structure of current collector 50 of battery 401 according to the present embodiment. FIG. 15 is an extracted view illustrating one power generating layer 100 and two adjacent current collectors 50 provided on either side of power generating layer 100, from among the plurality of power generating layers 100 and the plurality of current collectors 50 in power generating element 5 of battery 401. As illustrated in FIG. 14 and FIG. 15, battery 401 according to the present embodiment differs from battery 1 according to Embodiment 1 in that current collector 50 includes protruding portion 451 that is different in shape from protruding portion 51.

As illustrated in FIG. 14 and FIG. 15, current collector 50 includes protruding portion 451 that protrudes beyond end surfaces 80 of the plurality of power generating layers 100 in side surface portion 11, and stacked portion 55 where the plurality of power generating layers 100 are stacked.

Current collector 50 also includes, in side surface portion 12, protruding portion 451 that protrudes beyond end surfaces 80 of the plurality of power generating layers 100. Hereinafter, protruding portion 451 in side surface portion 11 will be described, but protruding portion 451 in side surface portion 12 has the same configuration and thus the description of protruding portion 451 in side surface portion 11 also applies to protruding portion 451 in side surface portion 12.

Protruding portion 451 specifically protrudes beyond the end surface of electrode layer 110 or counter electrode layer 120 at end surface 80 of power generating layer 100 that is adjacent to current collector 50. Protruding portion 451, for example, is a region that is outward from the end surface of electrode layer 110 or counter electrode layer 120 at end surface 80 of power generating layer 100 that is adjacent to current collector 50, when viewed in the stacking direction of current collector 50.

Protruding portion 451 includes anchor portion 452 that is thicker than stacked portion 55. Anchor portion 452 extends beyond stacked portion 55 in a direction perpendicular to the main surfaces of power generating layers 100. Anchor portion 452 protrudes from the main surface of protruding portion 451 in a stepped shape, in the stacking direction. When side surface portion 11 or 12 is viewed from the outside in a direction parallel to the main surface of power generating layer 100, anchor portion 452 includes a portion of protruding portion 451 that does not overlap stacked portion 55. Anchor portion 452 is formed by increasing the thickness of a part of protruding portion 451. Note that anchor portion 452 is not a portion whose thickness is increased due to the surface roughness of the material of current collector 50, etc., but rather is a portion whose thickness is greater than stacked portion 55 as a result of intentional processing to increase the thickness performed on current collector 50.

Protruding portion 451 includes anchor portion 452 at the leading end of protruding portion 451. Anchor portion 452 included in protruding portion 451 is formed, for example, by bending the leading end of protruding portion 451 one or more times in a direction parallel to the stacking direction, or by welding a piece of metal thicker than stacked portion 55 to the leading end of protruding portion 451.

The position and number of thicker parts in protruding portion 451 are not limited to this example. For example, current collector 50 may include protruding portion 451a, such as protruding portion 451a illustrated in FIG. 14 and FIG. 15, which includes, inward of the leading end of protruding portion 451a, anchor portion 452a that is thicker than stacked portion 55. In protruding portion 451a, for example, applying a large amount of pressure across the leading end of protruding portion 451a creates a portion slightly inward of the leading end that is thicker than stacked portion 55. Current collector 50 may include protruding portions that are thicker than stacked portions 55 at two or more places.

When protruding portion 451 and stacked portion 55 are projected onto projection plane P1 using the projection direction (white arrows in the figure) and projection plane P1 described in Embodiment 1, the projected area of protruding portion 451 is larger than the projected area of stacked portion 55. More specifically, since protruding portion 451 includes anchor portion 452 that extends beyond stacked portion 55, the projected area of protruding portion 451 is larger than the projected area of stacked portion 55 by the projected area of anchor portion 452.

Thus, the projected area of protruding portion 451 is larger than the projected area of stacked portion 55, which means the mechanical connection between current collector 50 and the terminals can be made stronger by the anchoring effect, and the connection area between protruding portion 451 and the terminals can be increased without enlarging the overall size of battery 401, just as in battery 1. In addition, by giving protruding portion 451 a thick portion, the electrical resistance of protruding portion 451 itself can be reduced. Therefore, the high current characteristics can be enhanced.

The maximum thickness of anchor portion 452 in protruding portion 451 is, for example, at least 1.5 times the thickness of stacked portion 55. This effectively increases the mechanical connection strength and connection area between current collector 50 and the terminal. The maximum thickness of anchor portion 452 in protruding portion 451 is, for example, less than the thickness of power generating layer 100.

Batteries including current collectors 50 that include protruding portions 51, such as batteries 201 and 301 described above and batteries 701 and 801 to be described below, may include current collectors 50 that include protruding portions 451 instead of protruding portions 51.

### Embodiment 5

Next, Embodiment 5 will be described. Hereinafter, description will focus on the differences from Embodiments 1 through 4 and description of common points may be omitted or simplified.

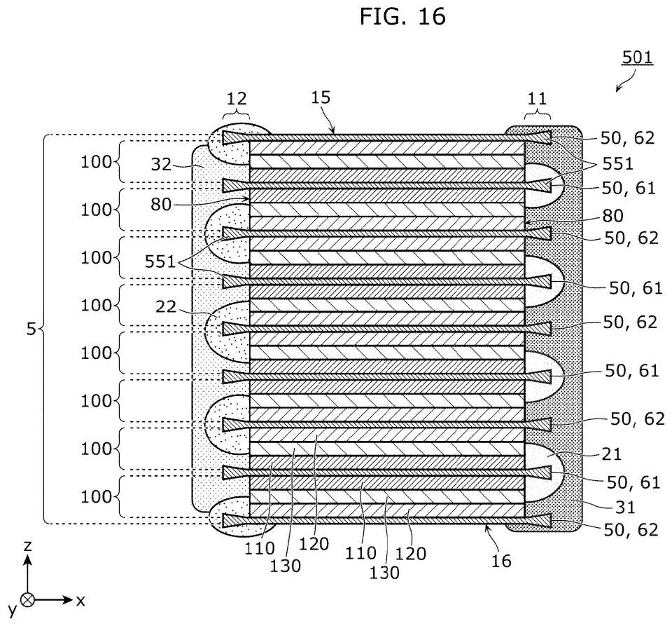

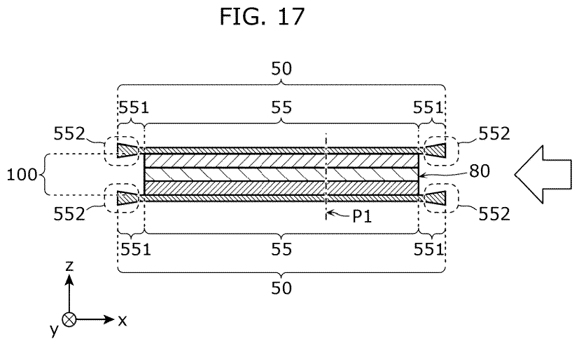

FIG. 16 is a cross-sectional view of battery 501 according to Embodiment 5. FIG. 17 is a cross-sectional view for explaining the detailed structure of current collector 50 of battery 501 according to the present embodiment. FIG. 17 is an extracted view illustrating one power generating layer 100 and two adjacent current collectors 50 provided on either side of power generating layer 100, from among the plurality of power generating layers 100 and the plurality of current collectors 50 in power generating element 5 of battery 501. As illustrated in FIG. 16 and FIG. 17, battery 501 according to the present embodiment differs from battery 1 according to Embodiment 1 in that current collector 50 includes protruding portion 551 that is different in shape from protruding portion 51.

As illustrated in FIG. 16 and FIG. 17, current collector 50 includes protruding portion 551 that protrudes beyond end surfaces 80 of the plurality of power generating layers 100 in side surface portion 11, and stacked portion 55 where the plurality of power generating layers 100 are stacked.

Current collector 50 also includes, in side surface portion 12, protruding portion 551 that protrudes beyond end surfaces 80 of the plurality of power generating layers 100. Hereinafter, protruding portion 551 in side surface portion 11 will be described, but protruding portion 551 in side surface portion 12 has the same configuration and thus the description of protruding portion 551 in side surface portion 11 also applies to protruding portion 551 in side surface portion 12.

Protruding portion 551 specifically protrudes beyond the end surface of electrode layer 110 or counter electrode layer 120 at end surface 80 of power generating layer 100 that is adjacent to current collector 50. Protruding portion 551, for example, is a region that is outward from the end surface of electrode layer 110 or counter electrode layer 120 at end surface 80 of power generating layer 100 that is adjacent to current collector 50, when viewed in the stacking direction of current collector 50.

Protruding portion 551 includes anchor portion 552 that is thicker than stacked portion 55. Anchor portion 552 extends beyond stacked portion 55 in a direction perpendicular to the main surfaces of power generating layers 100. When side surface portion 11 or 12 is viewed from the outside in a direction parallel to the main surface of power generating layer 100, anchor portion 552 includes a portion of protruding portion 551 that does not overlap stacked portion 55. Anchor portion 552 is formed by increasing the thickness of protruding portion 551 progressively towards the leading end.

When protruding portion 551 and stacked portion 55 are projected onto projection plane P1 using the projection direction (white arrows in the figure) and projection plane P1 described in Embodiment 1, the projected area of protruding portion 551 is larger than the projected area of stacked portion 55. More specifically, since protruding portion 551 includes anchor portion 552 that extends beyond stacked portion 55, the projected area of protruding portion 551 is larger than the projected area of stacked portion 55 by the projected area of anchor portion 552.

Thus, the projected area of protruding portion 551 is larger than the projected area of stacked portion 55, which means the mechanical connection between current collector 50 and the terminals can be made stronger by the anchoring effect, and the connection area between protruding portion 551 and the terminals can be increased without enlarging the overall size of battery 501, just as in battery 1. In addition, by giving protruding portion 551 a thick portion, the electrical resistance of protruding portion 551 itself can be reduced. Therefore, the high current characteristics can be enhanced.

The maximum thickness of anchor portion 552 in protruding portion 551 is, for example, at least 1.5 times the thickness of stacked portion 55. This effectively increases the mechanical connection strength and connection area between current collector 50 and the terminal. The maximum thickness of anchor portion 552 in protruding portion 551 is, for example, less than the thickness of power generating layer 100.

Batteries including current collectors 50 that include protruding portions 51, such as batteries 201 and 301 described above and batteries 701 and 801 to be described below, may include current collectors 50 that include protruding portions 551 instead of protruding portions 51.

### Embodiment 6

Next, Embodiment 6 will be described. Hereinafter, description will focus on the differences from Embodiments 1 through 5 and description of common points may be omitted or simplified.

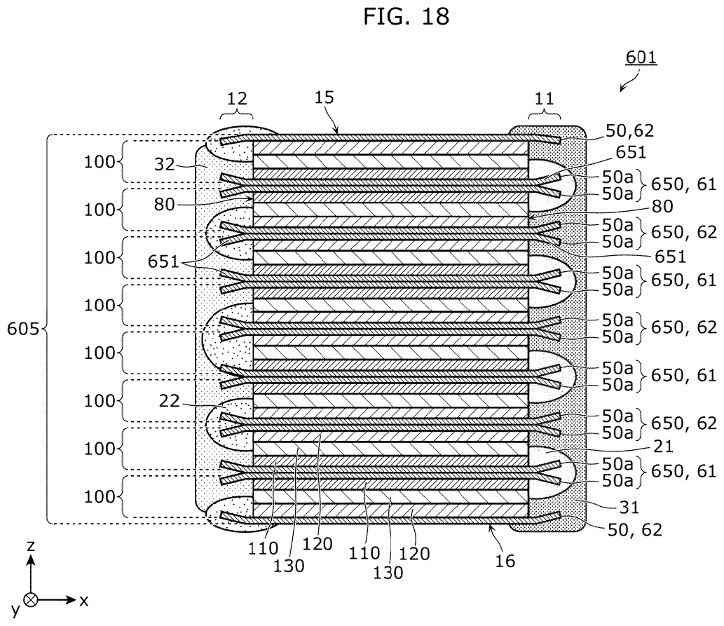

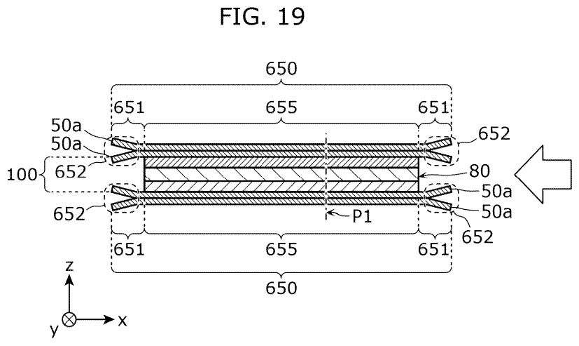

FIG. 18 is a cross-sectional view of battery 601 according to Embodiment 6. FIG. 19 is a cross-sectional view for explaining the detailed structure of current collector 650 of battery 601 according to the present embodiment. FIG. 19 is an extracted view illustrating one power generating layer 100 and two adjacent current collectors 650 provided on either side of power generating layer 100, from among the plurality of power generating layers 100 and the plurality of current collectors 650 in power generating element 605 of battery 601. As illustrated in FIG. 18 and FIG. 19, battery 601 according to the present embodiment differs from battery 1 according to Embodiment 1 in that it includes power generating element 605, which has a configuration where some of the plurality of current collectors 50 in power generating element 5 are changed to current collector 650, instead of power generating element 5.

Power generating element 605 includes a plurality of power generating layers 100 and a plurality of current collectors 50 and 650. In power generating element 605, two adjacent power generating layers 100 among the plurality of power generating layers 100 are stacked with one of the plurality of current collectors 650 interposed therebetween. Current collectors 50 are arranged at the top-most portion and bottom-most portion of power generating element 605. Stated differently, power generating element 605 has a configuration achieved by replacing current collectors 50 other than the top-most and bottom-most current collectors 50 in power generating element 5 with current collectors 650.

Current collector 650 has a multilayer structure of two stacked current collecting layers 50a. The two current collecting layers 50a are stacked directly together or with an intermediate layer therebetween (not shown in the drawings), and are at the same potential. Current collecting layer 50a, for example, includes the same material as current collector 50 described above. The intermediate layer is, for example, conductive, but may be insulating. The intermediate layer includes, for example, a conductive resin material.

Current collector 650 includes protruding portion 651 that protrudes beyond end surfaces 80 of the plurality of power generating layers 100 in side surface portion 11, and stacked portion 655 where the plurality of power generating layers 100 are stacked. Current collector 650 also includes, in side surface portion 12, protruding portion 651 that protrudes beyond end surfaces 80 of the plurality of power generating layers 100. Hereinafter, protruding portion 651 in side surface portion 11 will be described, but protruding portion 651 in side surface portion 12 has the same configuration and thus the description of protruding portion 651 in side surface portion 11 also applies to protruding portion 651 in side surface portion 12.

Protruding portion 651 specifically protrudes beyond the end surface of electrode layer 110 or counter electrode layer 120 at end surface 80 of power generating layer 100 that is adjacent to current collector 650. Protruding portion 651 is a region that is outward from the end surface of electrode layer 110 or counter electrode layer 120 at end surface 80 of power generating layer 100 that is adjacent to current collector 650, when viewed in the stacking direction of current collector 650.

Protruding portion 651 is bifurcated. More specifically, protruding portion 651 is bifurcated by bending and separating the end portions of the two stacked current collecting layers 50a away from each other. If current collecting layers 50a are stacked with an intermediate layer therebetween, the intermediate layer may be present on the surface of the separated portions of current collecting layers 50a.

Protruding portion 651 includes anchor portion 652 that extends beyond stacked portion 655 in a direction perpendicular to the main surface of power generating layer 100. When side surface portion 11 or 12 is viewed from the outside in a direction parallel to the main surface of power generating layer 100, anchor portion 652 includes a portion of protruding portion 651 that does not overlap stacked portion 655. Anchor portion 652 is formed by the bifurcation of protruding portion 651.

Protruding portion 651 is bifurcated at one point inward of the center of protruding portion 651. The number and position of bifurcations in protruding portion 651 are not limited to this example.

Stacked portion 655 is the region of current collector 650 that is located on the end surface 80 side of protruding portion 651, connected to protruding portion 651, and overlaps electrode layer 110 or counter electrode layer 120 of power generating layer 100 adjacent to current collector 650. The boundary between protruding portion 651 and stacked portion 655 is located at the end surface of electrode layer 110 or counter electrode layer 120 of power generating layer 100 that is adjacent to current collector 650, when viewed in the stacking direction.

When protruding portion 651 and stacked portion 655 are projected onto projection plane P1 using the projection direction (white arrows in the figure) and projection plane P1 described in Embodiment 1, the projected area of protruding portion 651 is larger than the projected area of stacked portion 655. More specifically, since protruding portion 651 includes anchor portion 652 that extends beyond stacked portion 655, the projected area of protruding portion 651 is larger than the projected area of stacked portion 655 by the projected area of anchor portion 652.

Thus, the projected area of protruding portion 651 is larger than the projected area of stacked portion 655, which means the mechanical connection between current collector 650 and the terminals can be made stronger by the anchoring effect, and the connection area between protruding portion 651 and the terminals can be increased without enlarging the overall size of battery 601, just as in battery 1.

Since protruding portion 651 is bifurcated, the connection area between current collector 650 and the terminals can be effectively increased compared to when a current collector that does not include a stacked configuration is bent. More specifically, protruding portion 651 is exposed when power generating element 605 is in a standalone state, and the entirety of the exposed protruding portion 651 is covered by counter electrode terminal 31 or electrode terminal 32. Protruding portion 651 is connected to counter electrode terminal 31 or electrode terminal 32 on both main surfaces corresponding to the upper and lower surfaces when the two current collecting layers 50a are not separated, as well as on the surfaces formed by the separation of the two current collecting layers 50a. The connection area between current collector 650 and the terminals is therefore larger. Protruding portion 651 is not limited to a structure in which the two current collecting layers 50a are bifurcated by separation. For example, current collector 650 may include a single current collecting layer 50a, and protruding portion 651 may be bifurcated by bonding a metal foil, for example, to a main surface of current collecting layer 50a.

Batteries including current collectors 50 that include protruding portions 51, such as batteries 201 and 301 described above and batteries 701 and 801 to be described below, may include current collectors 650 instead of current collectors 50.

### Embodiment 7

Next, Embodiment 7 will be described. Hereinafter, description will focus on the differences from Embodiments 1 through 6 and description of common points may be omitted or simplified.

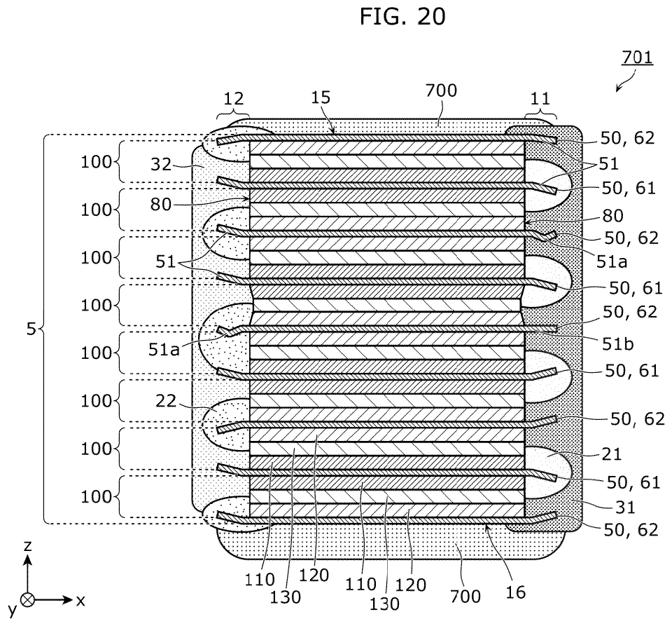

FIG. 20 is a cross-sectional view of battery 701 according to Embodiment 7. As illustrated in FIG. 20, battery 701 according to the present variation differs from battery 1 according to Embodiment 1 in that it additionally includes sealing components 700.

Sealing components 700 expose at least a portion of each of counter electrode terminal 31 and electrode terminal 32, and seal power generating element 5. Sealing components 700, for example, are provided so that power generating element 5 is not exposed.

Sealing component 700 is formed using, for example, electrically insulating materials. Generally known materials for battery sealing components, such as sealants, for example, can be used as the insulating material. For example, a resin material can be used as the insulating material. The insulating material may be an insulating and non-ion-conductive material. For example, the insulating material may be at least one of epoxy resin, acrylic resin, polyimide resin, or silsesquioxane.

Sealing component 700 may include a plurality of different insulating materials. For example, sealing component 700 may have a multilayer structure. Each layer of the multilayer structure may be formed using a different material and have different properties.

Sealing component 700 may include particulate metal oxide material. Silicon oxide, aluminum oxide, titanium oxide, zinc oxide, cerium oxide, iron oxide, tungsten oxide, zirconium oxide, calcium oxide, zeolite, glass, etc., can be used as the metal oxide material. For example, sealing component 700 may be formed using a resin material in which a plurality of metal oxide material particles are dispersed.

The particle size of the metal oxide material is, for example, less than the spacing of current collectors 50. The particle shape of the metal oxide material is, for example, but not limited to, spherical, ellipsoidal, or rod-shaped.

Sealing components 700 improve the reliability of battery 701 in various ways, including mechanical strength, short-circuit protection, and moisture proofing.

Although battery 701 is exemplified as including battery 1 according to Embodiment 1 further including sealing components 700, other batteries, such as those according to Embodiment 2 through 6 above and Embodiment 8 below, may also include sealing components 700.

### Embodiment 8

Next, Embodiment 8 will be described. Hereinafter, description will focus on the differences from Embodiments 1 through 7 and description of common points may be omitted or simplified.

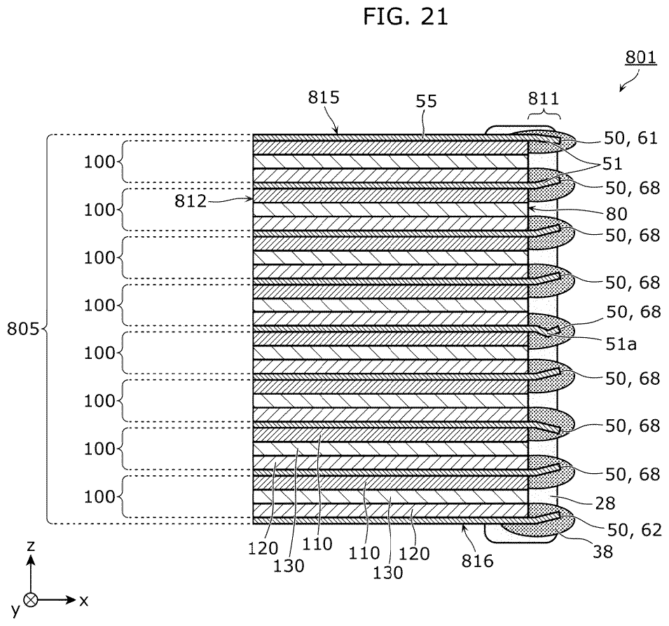

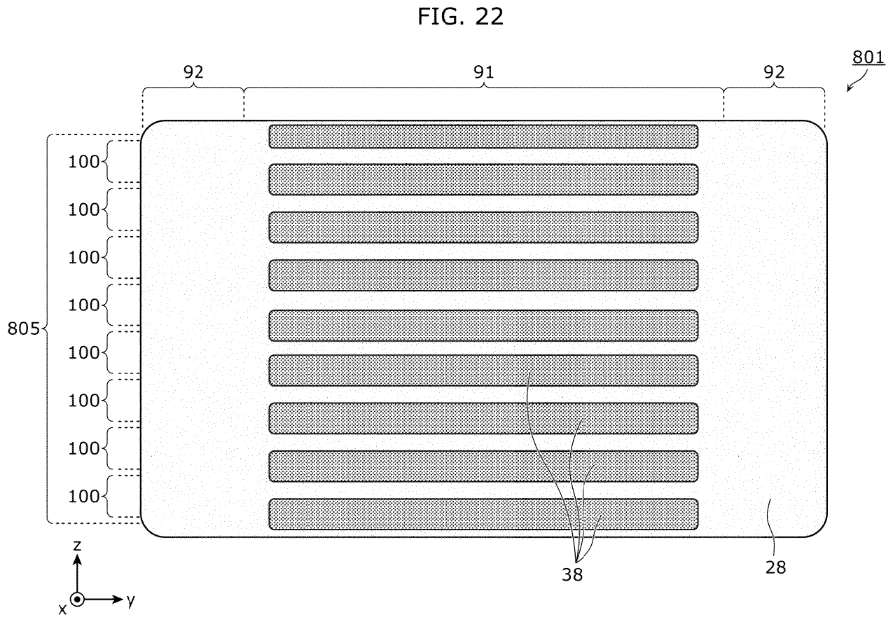

FIG. 21 is a cross-sectional view of battery 801 according to Embodiment 8. FIG. 22 is a plan view illustrating the positional relationship between side surface portion 811 of power generating element 805 according to present embodiment and insulating layer 28 and connection terminals 38 on side surface portion 811. FIG. 22 is a plan view of battery 801 in FIG. 21 when viewed from the positive direction of the x-axis.

As illustrated in FIG. 21, battery 801 according to the present embodiment differs from battery 1 according to Embodiment 1 in that it includes power generating element 805, insulating layer 28, and connection terminals 38 instead of power generating element 5, electrode insulating layers 21, counter electrode insulating layers 22, counter electrode terminal 31, and electrode terminal 32.

Similar to power generating element 5, power generating element 805 includes a plurality of power generating layers 100 and a plurality of current collectors 50. Similar to power generating element 5, in power generating element 805, two adjacent power generating layers 100 among the plurality of power generating layers 100 are stacked with one of the plurality of current collectors 50 interposed therebetween. Each of the plurality of power generating layers 100 of power generating element 5 is sandwiched between two adjacent current collectors 50. Power generating element 805 differs from power generating element 5 in that a plurality of power generating layers 100 are stacked so that they are electrically connected in series. In power generating element 805, the plurality of power generating layers 100 are stacked along the z-axis such that the order in which the layers of power generating layer 100 are layered is the same in each and every power generating layer 100. Thus, a plurality of power generating layers 100 are stacked so as to be electrically connected in series.

The plurality of current collectors 50 other than the top-most and bottom-most current collectors 50 are stacked and in contact with electrode layer 110 on one main surface without solid electrolyte layer 130 interposed therebetween, and are stacked and in contact with counter electrode layer 120 on the other main surface without solid electrolyte layer 130 interposed therebetween. Stated differently, the plurality of current collectors 50 other than the top-most and bottom-most current collectors 50 are bipolar current collectors 68, with one main surface electrically connected to electrode layer 110 and the other main surface electrically connected to counter electrode layer 120. Two adjacent power generating layers 100 are stacked with bipolar current collector 68 interposed therebetween. In power generating element 805, the top-most current collector 50 is electrode current collector 61 and the bottom-most current collector 50 is counter electrode current collector 62.

Power generating element 805 includes four side surface portions in locations corresponding to the four side surface portions 11, 12, 13, and 14 of power generating element 5 and two main surfaces in locations corresponding to the two main surfaces 15 and 16 of power generating element 5. More specifically, as illustrated in FIG. 21, power generating element 805 includes side surface portion 811 at a location corresponding to side surface portion 11 and side surface portion 812 at a location corresponding to side surface portion 12. Furthermore, power generating element 805 includes main surface 815 at a location corresponding to main surface 15, and main surface 816 at a location corresponding to main surface 16.

In power generating element 805, the plurality of current collectors 50 each include protruding portion 51 or 51a protruding beyond end surfaces 80 of power generating layers 100 in side surface portion 811, and stacked portion 55. The structures of protruding portion 51 and 51a and stacked portion 55 are the same as in Embodiment 1.

In power generating element 805, the plurality of current collectors 50 each do not include protruding portion protruding beyond end surfaces 80 of power generating layers 100 in side surface portion 812. Therefore, side surface portion 812 is a flat surface where positions of the end surfaces of the plurality of power generating layers 100 and the plurality of current collectors 50 are aligned when viewed in the z-axis direction. Note that protruding portion 51 may be formed on current collectors 50 in side surface portion 812 as well.

Connection terminals 38 are provided for each of the plurality of current collectors 50 and are connected to their corresponding current collectors 50. Connection terminal 38 is one example of the conductive component. More specifically, each connection terminal 38 covers and is in contact with the main surfaces and end surface of protruding portion 51 of the corresponding current collector 50. In the illustrated example, the entirety of protruding portion 51 of current collector 50 is buried in connection terminal 38.

Connection terminal 38 may cover a portion of end surface 80 of power generating layer 100 adjacent to its corresponding current collector 50. More specifically, connection terminal 38 may be in contact with the end surface of electrode layer 110 or counter electrode layer 120 of power generating layer 100 adjacent to its corresponding current collector 50. However, each connection terminal 38 is not in contact with the end surfaces of electrode layer 110 or counter electrode layer 120 stacked on the other side of solid electrolyte layer 130 relative to current collector 50 corresponding to that connection terminal 38.

The materials listed above as those used for counter electrode terminal 31 and electrode terminal 32 can be used for connection terminal 38. A plurality of connection terminals 38 are formed using the same material as each other, but may be formed using different materials. External electrodes may be further formed on connection terminals 38 by some other method such as plating, printing, or soldering. The formation of external electrodes can, for example, improve the mountability of battery 801.

For example, connection terminal 38 can be used to monitor the condition of each power generating layer 100 by measuring the potential of connection terminal 38. It is therefore possible to, for example, prevent overcharging and overdischarging. If there is variation in the state of charge among individual power generating layers 100, connection terminals 38 can be used to charge and discharge individual power generating layers 100 to reduce the variation in the state of charge.

As illustrated in FIG. 22, side surface portion 811 includes protruding region 91 and contiguous regions 92 positioned on both sides of protruding region 91, similar to battery 1. The plurality of connection terminals 38 are aligned in the stacking direction in protruding region 91 when side surface portion 811 is viewed straight on. The plurality of connection terminals 38 extend in a direction parallel to the main surfaces of the plurality of power generating layers 100 when side surface portion 811 is viewed straight on, and have a stripe shape. Note that side surface portion 811 need not include contiguous region 92, and may entirely be protruding region 91.

As illustrated in FIG. 21 and FIG. 22, insulating layer 28 covers side surface portion 811 so as to expose at least a portion of each of the plurality of connection terminals 38. Insulating layer 28 is one example of the insulating component. In the present embodiment, insulating layer 28 covers the entirety of the regions of side surface portion 811 that are not covered by connection terminals 38. The exposed portion of power generating element 805 at side surface portion 811 is covered by insulating layer 28, thereby inhibiting collapse and short circuits at the end surface of each layer. Note that battery 801 does not need to include insulating layer 28.

Insulating layer 28 may continuously cover the region of power generating element 805 from main surface 815 to main surface 816. In such cases, for example, part of insulating layer 28 is provided in contact with main surface 815, and another part is provided in contact with main surface 816.

The materials listed above as those used for electrode insulating layer 21 and counter electrode insulating layer 22 can be used for insulating layer 28.

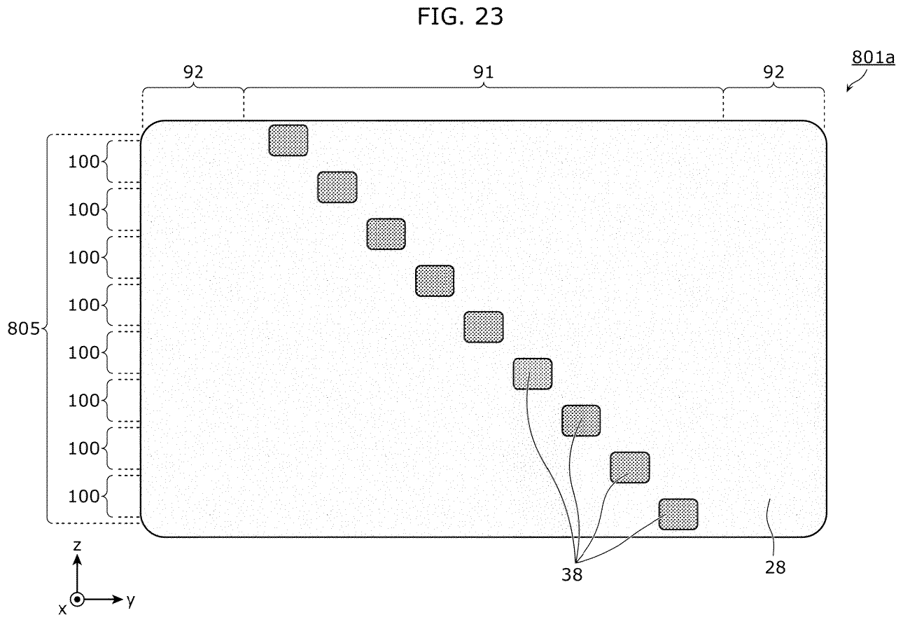

The arrangement of the plurality of connection terminals 38 when side surface portion 811 is viewed straight on is not limited to the example illustrated in FIG. 22. For example, the plurality of connection terminals 38 may be formed over the entire length of the end surface of current collector 50 when side surface portion 811 is viewed straight on. As illustrated in FIG. 23, the plurality of connection terminals 38 may be aligned in a direction inclined with respect to the stacking direction when side surface portion 811 is viewed straight on. FIG. 23 is a plan view of battery 801a according to a variation of Embodiment 8 when viewed from the side (positive x-axis direction). In battery 801a, for example, the plurality of connection terminals 38 do not overlap each other when viewed in the stacking direction. This inhibits the plurality of connection terminals 38 from contacting each other and causing a short circuit.

### (Manufacturing Method)

Next, the battery manufacturing method according to the above embodiments will be described. Each manufacturing method described below is merely one example. The manufacturing method of a battery according to the above embodiments is not limited to the following examples.

The manufacturing method of a battery according to the embodiments includes, for example, a first step of preparing a plurality of unit cells, a second step of forming a power generating element, which is one example of a stacked body, and a third step of forming a conductive component.

### Manufacturing Method Example 1

First, Manufacturing Method Example 1 for a battery according to the embodiments will be described.

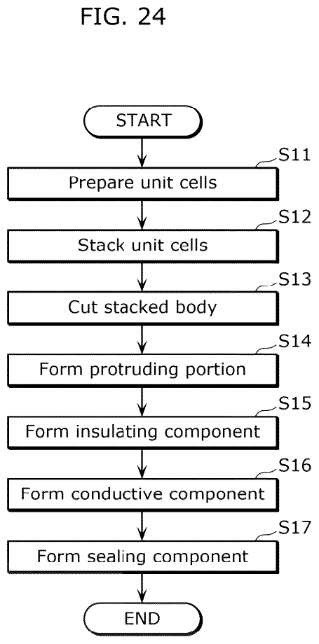

FIG. 24 is flowchart illustrating Manufacturing Method Example 1 for batteries according to each embodiment. Manufacturing Method Example 1 is a manufacturing method for manufacturing batteries 1, 401, 501, 601, 701, and 801, for example. The following description of Manufacturing Method Example 1 focuses on the manufacturing of battery 1. In Manufacturing Method Example 1, step S11 corresponds to the first step, steps S12, S13, and S14 correspond to the second step, and step S16 corresponds to the third step.

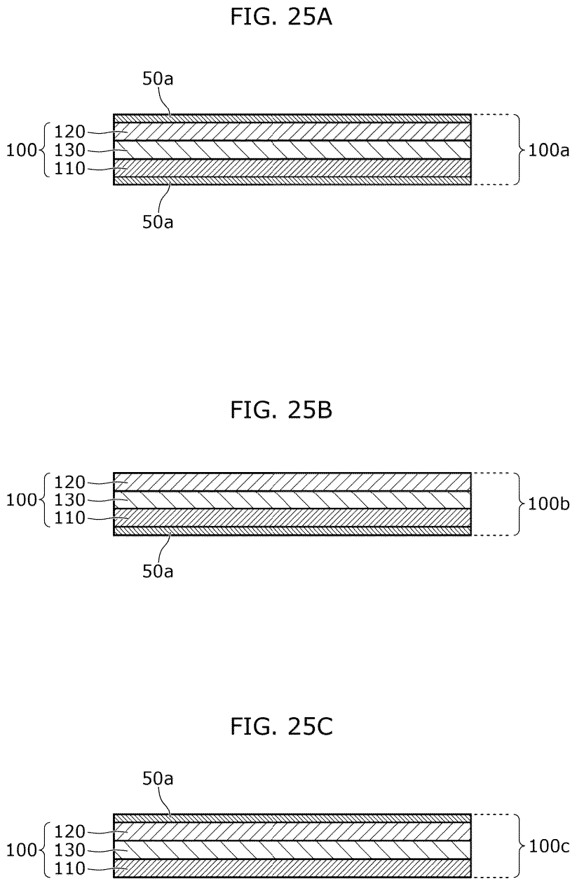

As illustrated in FIG. 24, first, a plurality of unit cells, each having a structure in which the power generating layer and the current collecting layer are stacked, are prepared (step S11). Next, a stacked body in which the plurality of unit cells are stacked is formed (step S12). As described above, power generating layer 100 includes electrode layer 110, counter electrode layer 120 arranged opposing electrode layer 110, and solid electrolyte layer 130 positioned between electrode layer 110 and counter electrode layer 120. Each of FIG. 25A through FIG. 25C is a cross-sectional views of one example of a unit cell.

As illustrated in FIG. 25A, unit cell 100a includes one power generating layer 100 and two current collecting layers 50a. In unit cell 100a, power generating layer 100 is arranged between the two current collecting layers 50a, and power generating layer 100 is in contact with each of the two current collecting layers 50a. More specifically, electrode layer 110 of power generating layer 100 contacts one of the two current collecting layers 50a, and counter electrode layer 120 of power generating layer 100 contacts the other of the two current collecting layers 50a.

Also, as illustrated in FIG. 25B and FIG. 25C, unit cell 100b and unit cell 100c each include one power generating layer 100 and one current collecting layer 50a.

In unit cell 100b, current collecting layer 50a is arranged on the side, of power generating layer 100, that is adjacent electrode layer 110, and is arranged opposing power generating layer 100 and in contact with electrode layer 110. In power generating layer 100 of unit cell 100b, the main surface, of counter electrode layer 120, that is on the side opposite the side adjacent solid electrolyte layer 130, is exposed.

In unit cell 100c, current collecting layer 50a is arranged on the side, of power generating layer 100, that is adjacent counter electrode layer 120, and is arranged opposing power generating layer 100 and in contact with counter electrode layer 120. In power generating layer 100 of unit cell 100c, the main surface, of electrode layer 110, that is on the side opposite the side adjacent solid electrolyte layer 130, is exposed.

For example, in step S11, at least one of the above-mentioned unit cells 100a, 100b, or 100c is prepared in accordance with the stacked configuration of the power generating elements included in the battery to be manufactured. For example, one unit cell 100a, a plurality of unit cells 100b, and a plurality of unit cells 100c are prepared. Unit cell 100a is arranged as the bottom-most layer, and unit cells 100b and 100c are stacked alternately toward the top. Here, unit cells 100b are stacked with a vertical orientation opposite the vertical orientation illustrated in FIG. 25B. This forms a stacked body with a stacked structure of power generating element 5 in which a plurality of power generating layers 100 and a plurality of current collectors 50, each of which is current collecting layer 50a, are stacked.

The method of forming a stacked body with a stacked structure of power generating element 5 is not limited to this example. For example, unit cell 100a may be arranged on the top-most layer. Alternatively, unit cell 100a may be arranged in a position other than the top-most or bottom-most layer. A plurality of unit cells 100a may be used. A unit of a unit cell with power generating layer 100 stacked on the main surfaces on both sides of current collecting layer 50a may be formed by performing double-sided coating on one current collecting layer 50a, and the formed unit may be stacked. The unit cell may be a unit cell that does not include current collecting layer 50a and consists of power generating layer 100.

When manufacturing a battery that includes power generating element 605, for example, a plurality of unit cells 100a are prepared and a plurality of unit cells 100a are stacked while alternately reversing the orientation in which the layers of power generating layer 100 are aligned. This forms a stacked body with a stacked structure of power generating element 605 in which a plurality of power generating layers 100 and a plurality of current collectors 650, each of which is a multilayer structure of two current collecting layers 50a, are stacked. In such cases, the plurality of unit cells 100a are stacked after applying, for example, a conductive resin material that serves as an intermediate layer on the main surface. This results in a plurality of unit cells 100a being stacked with intermediate layers interposed therebetween. The plurality of unit cells 100a may be stacked with insulating adhesive material interposed therebetween that serves as the intermediate layer, or stacked directly.

When manufacturing a battery that includes power generating element 805, one unit cell 100a and a plurality of unit cells 100b or a plurality of unit cells 100c are prepared, and the unit cells are stacked while keeping the orientation in which the layers of power generating layer 100 are aligned the same. This forms a stacked body with a stacked structure of power generating element 805 in which a plurality of power generating layers 100 and a plurality of current collectors 50, each of which is current collecting layer 50a, are stacked.

Next, the stacked body formed in step S12 is cut (step S13). For example, by cutting the end portion of a stacked body of a plurality of unit cells in a batch in the stacking direction, power generating element 5, 605, or 805 in which each side surface is a cut, flat surface can be formed. For example, in the case of power generating element 5, a structure similar to that illustrated in FIG. 6 is formed all around. This allows for each layer to have the same area without being affected by variations in the area of each layer's coating. As a result, battery capacity variation is reduced and battery capacity accuracy is improved. The cutting process is performed, for example, by mechanical cutting using a blade, ultrasonic cutting using an ultrasonic cutter, laser cutting, or jet cutting.

Step S13 may be omitted if the unit cell is formed in advance into a shape corresponding to the desired shape of power generating element 5, 605, or 805.

Next, a protruding portion protruding beyond the end surface of the power generating layer is formed on the current collector (step S14). Here, protruding portion 51 and stacked portion 55 are formed so that the projected area of protruding portion 51 is larger than the projected area of stacked portion 55 when protruding portion 51 and stacked portion 55 are projected from outside side surface portion 11 in a direction parallel to the main surfaces of power generating layers 100 onto projection plane P1 perpendicular to the main surfaces of power generating layers 100.

For example, first, in side surface portion 11 and 12 of power generating element 5, the end portions of current collectors 50 are made to protrude beyond end surfaces 80 of power generating layers 100 by performing a receding process that recedes power generating layers 100 from current collectors 50. In the receding process, power generating layers 100 are receded from current collectors 50 by, for example, polishing, sandblasting, brushing, etching, laser irradiation, or plasma irradiation of each power generating layer 100.

When polishing, sandblasting, or brushing is used to recede power generating layers 100, for example, the difference in processing speed between current collectors 50 and power generating layers 100 is used to recede power generating layers 100, which is more easily polished, sandblasted, or brushed away.

When etching is used to recede power generating layers, for example, etching is performed under conditions where the etching rate of current collectors 50 is less than the etching rate of each power generating layer 100. For example, wet etching can be used for the etching.

When laser or plasma irradiation is used to recede power generating layers 100, for example, irradiation processing is performed under conditions where the processing speed of current collectors 50 is less than the processing speed of each power generating layer 100. For example, oxygen plasma can be used for the plasma irradiation.

In the receding process, for example, a protective component is provided in regions other than where current collectors 50 are protruded on the side surface portions of the power generating element (for example, in contiguous regions 92 described above), and only the desired regions are receded. This results in power generating element 5 with protruding region 91 and contiguous regions 92 in side surface portion 11 and side surface portion 12.

Next, an area expansion process is performed to mechanically bend protruding portion 51 of current collector 50 that protrudes beyond end surfaces 80 of power generating layers 100 so that the projected area of protruding portion 51 is larger than the projected area of stacked portion 55. With this, at least one anchor portion 52 is formed in side surface portions 11 and 12 by bending at least one protruding portion 51 of current collector 50. For example, mechanical bending involves bending protruding portions 51 of the plurality of current collectors 50 in one batch by pressing a plate-shaped pressing member or the like against the end surface of the unit cell, such as by pressing a plate-shaped pressing member or the like against the plurality of current collectors 50. Protruding portions 51 of the plurality of current collectors 50 may be bent by pinching and bending them individually, for example. One or more protruding portion 51 may be bent by wind pressure, such as by blowing gas. Depending on the conditions for the bending, current collector 50 may be bent so that anchor portion 452 is formed at the leading end of current collector 50 to form protruding portion 451 in battery 401.

When manufacturing battery 501, for example, in step S13, as an area expansion process, part of the end portions of power generating layers 100 is omitted by batch cutting under conditions of high mechanical friction using mechanical or ultrasonic cutting, etc., and the end portions of current collectors 50 are pressed into the omissions. This forms anchor portion 552 that increases in thickness toward the leading end of current collector 50, and in a subsequent step S14, protruding portion 551 is formed by the receding process. Stated differently, part of the process of forming protruding portion 551 may be performed in parallel with step S13.

Protruding portion 51, 451, or 551 may be formed by forming power generating element 5 using a unit cell including current collecting layer 50a that has been pre-processed into the shape of anchor portion 52, 452, or 552, followed by the receding process of power generating layers 100. Stated differently, part of the process of forming the protruding portion may be performed in parallel with step S11.

When manufacturing battery 601, for example, after performing the receding process of power generating layers 100 for power generating element 605, an area expansion process is performed to separate the end portions of the two stacked current collecting layers 50a to form protruding portion 651. If the two current collecting layers 50a are stacked with an intermediate layer interposed therebetween, the two current collecting layers 50a are separated by removing the intermediate layer by, for example, dissolving the material with a solvent. The two current collecting layers 50a may be separated by removing the intermediate layer at the point of separation by heating, plasma irradiation, or laser irradiation. The receding process of power generating layers 100 and the removal of the intermediate layer may be performed simultaneously using a method such as dissolving, heating, plasma irradiation, or laser irradiation of the material.

Next, an insulating component is formed on a side surface portion of the power generating element (step S15). More specifically, electrode insulating layer 21 is formed on side surface portion 11 of power generating element 5 and counter electrode insulating layer 22 is formed on side surface portion 12 of power generating element 5.

Electrode insulating layer 21 and counter electrode insulating layer 22 are formed, for example, by coating and curing a liquid resin material. Coating is done by inkjet, spray, screen printing, or gravure printing. Curing is performed by drying, heating, or light irradiation, depending on the resin material used.

When forming electrode insulating layer 21 and counter electrode insulating layer 22, a protective component may be formed by masking with tape or the like or by resist treatment in regions where no insulating component should be formed so that the areas connected to counter electrode terminal 31 and electrode terminal 32 are not insulated. After electrode insulating layer 21 and counter electrode insulating layer 22 are formed, the protective component can be removed to ensure conductivity at the connection points with the terminals.

Next, a conductive component is formed on a side surface portion of the power generating element (step S16). More specifically, counter electrode terminal 31 is formed on side surface portion 11 of power generating element 5 and electrode terminal 32 is formed on side surface portion 12 of power generating element 5. Counter electrode terminal 31 and electrode terminal 32 are formed to be connected to the main surfaces of protruding portion 51. Counter electrode terminal 31 is formed in contact with the end surface of counter electrode layer 120 in side surface portion 11, and electrode terminal 32 is formed in contact with the end surface of electrode layer 110 in side surface portion 12.

For example, counter electrode terminal 31 is formed by coating and curing a conductive resin to cover electrode insulating layer 21 and the portion of side surface portion 11 not covered by electrode insulating layer 21. Counter electrode terminal 31 is thus connected to the main surfaces of protruding portion 51 of each counter electrode current collector 62 of power generating element 5. Electrode terminal 32 is formed by coating and curing a conductive resin to cover counter electrode insulating layer 22 and the portion of side surface portion 12 not covered by counter electrode insulating layer 22. Electrode terminal 32 is thus connected to the main surfaces of protruding portion 51 of each electrode current collector 61 of power generating element 5. Counter electrode terminal 31 and electrode terminal 32 may be formed by printing, plating, vapor deposition, sputtering, welding, soldering, bonding, or some other method.

Battery 1 illustrated in FIG. 1 can be produced through these above-described processes.

The process of pressing the plurality of unit cells prepared in step S11 in the stacking direction may be performed individually or after stacking the plurality of unit cells.

In the case of manufacturing battery 701, after forming the conductive component (step S16), sealing component 700 illustrated in FIG. 20 may be formed (step S17). Sealing component 700 is formed, for example, by coating and curing a liquid resin material. Coating is done by inkjet, spray, screen printing, or gravure printing. Curing is performed by drying, heating, or light irradiation, based on the resin material used.

### Manufacturing Method Example 2

Next, Manufacturing Method Example 2 for a battery according to the embodiments will be described. Hereinafter, description will focus on the differences from Manufacturing Method Example 1 and description of common points may be omitted or simplified.

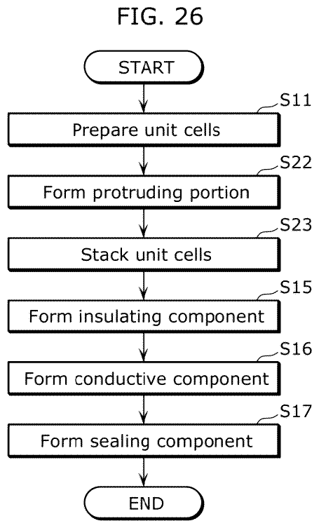

FIG. 26 is flowchart illustrating Manufacturing Method Example 2 for batteries according to each embodiment. Manufacturing Method Example 2 is a manufacturing method for manufacturing battery 201, for example. In Manufacturing Method Example 2, step S11 corresponds to the first step, steps S22 and S23 correspond to the second step, and step S16 corresponds to the third step.

As illustrated in FIG. 26, first, a plurality of unit cells, each having a structure in which the power generating layer and the current collecting layer are stacked, are prepared (step S11).

Next, a protruding portion protruding beyond the end surface of the power generating layer is formed on the current collector (step S22). In step S22, current collector 50 consisting of current collecting layer 50a is protruded beyond end surface 80 of power generating layer 100 by performing a receding process that recedes power generating layer 100 of the unit cell before stacking from current collecting layer 50a. In the receding process in step S22, in addition to the method mentioned in step S14 of Manufacturing Method Example 1 above, in a predetermined region in plan view of the unit cell prepared in step S11, by partially cutting power generating layer 100 to leave only current collecting layer 50a of the unit cell, power generating layer 100 may be receded from current collecting layer 50a to cause current collector 50 to protrude beyond end surface 80 of power generating layer 100. For example, the unit cell is divided by cutting power generating layer 100 along the stacking direction and stopping the cutting up to the front of current collecting layer 50a. By removing one of divided power generating layers 100, only current collecting layer 50a of the unit cell can be left in a given region in plan view. Current collecting layer 50a in given region will eventually become protruding portion 51 of current collector 50.

Next, a power generating element in which the plurality of unit cells with protruding current collectors are stacked is formed (step S23). For example, protruding portions 51 are arranged so that only counter electrode current collectors 62 protrude in side surface portion 11 and only current collectors 61 protrude in side surface portion 12, and a plurality of unit cells are stacked by aligning the positions of power generating layers 100 when viewed in the stacking direction. Protruding portions 51 are then subjected to an area expansion process, such as mechanical bending, in the same manner as described above to form power generating element 5 illustrated in FIG. 12. Stated differently, part of the process of forming protruding portion 51 may be performed in parallel with step S23. The bending of protruding portions 51 may be performed on current collectors 50 of the unstacked unit cells before step S23.

Next, an insulating component and a conductive component are formed on a side surface portion of the power generating element (steps S15 and S16). Battery 201 illustrated in FIG. 12 can be produced through these above-described processes. In addition, if necessary, a sealing component may be formed on battery 201 (step S17).

Furthermore, by applying Manufacturing Method Example 2, batteries 1, 401, 501, 601, 701, and 801 can also be manufactured. Stated differently, in step S22, a protruding portion in the shape corresponding to batteries 1, 401, 501, 601, 701, and 801 may be formed in the unit cell before stacking, and a plurality of unit cells with the protruding portion may be stacked. [Manufacturing Method Example 3]

Next, Manufacturing Method Example 3 for a battery according to the embodiments will be described. Hereinafter, description will focus on the differences from Manufacturing Method Example 1 and description of common points may be omitted or simplified.

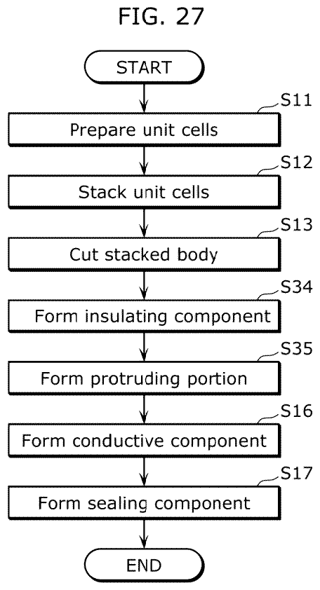

FIG. 27 is flowchart illustrating Manufacturing Method Example 3 for batteries according to each embodiment. Manufacturing Method Example 3 is a manufacturing method for manufacturing battery 301, for example. In Manufacturing Method Example 3, step S11 corresponds to the first step, steps S12, S13, S34, and S35 correspond to the second step, and step S16 corresponds to the third step.

As illustrated in FIG. 27, first, a plurality of unit cells, each having a structure in which the power generating layer and the current collecting layer are stacked, are prepared (step S11). Next, a stacked body in which the plurality of unit cells are stacked is formed (step S12). The stacked body is then cut (step S13). The steps up to this point are the same as in Manufacturing Method Example 1. Next, an insulating component is formed on a side surface portion of the power generating element (step S34). More specifically, in power generating element 5 in a state before protruding portion 51 is formed on current collector 50, electrode insulating layer 21 is formed on side surface portion 11 and counter electrode insulating layer 22 is formed on side surface portion 12. The same method as in step S15 above can be used to form electrode insulating layer 21 and counter electrode insulating layer 22.

Next, a protruding portion protruding beyond the end surface of the power generating layer is formed on the current collector (step S35). For example, first, a receding process is performed on side surface portions 11 and 12 of power generating element 5, which recedes power generating layers 100 from current collectors 50. In side surface portion 11, since electrode layer 110 and electrode current collector 61 are covered by electrode insulating layer 21, electrode insulating layer 21 functions as a protective component during the receding process. As a result, in side surface portion 11, counter electrode layer 120 and solid electrolyte layer 130 of power generating layer 100 are receded to form end surface 380a, and protruding portion 51 protruding beyond end surface 380a is formed on counter electrode current collector 62. In side surface portion 12, since counter electrode layer 120 and counter electrode current collector 62 are covered by counter electrode insulating layer 22, counter electrode insulating layer 22 functions as a protective component during the receding process. As a result, in side surface portion 12, electrode layer 110 and solid electrolyte layer 130 of power generating layer 100 are receded to form end surface 380b, and protruding portion 51 protruding beyond end surface 380b is formed on electrode current collector 61. Protruding portions 51 are then subjected to an area expansion process, such as mechanical bending, in the same manner as described above to form power generating element 5 illustrated in FIG. 13.

If necessary, electrode insulating layer 21 and counter electrode insulating layer 22 may be re-formed after the receding process. This makes it possible to increase the protective function of electrode insulating layer 21 and counter electrode insulating layer 22 for protecting power generating element 5 by re-forming, even when part of electrode insulating layer 21 and counter electrode insulating layer 22 have been removed by the receding process.

Next, a conductive component is formed on a side surface portion of the power generating element (step S16). Battery 301 illustrated in FIG. 13 can be produced through these above-described processes. In addition, if necessary, a sealing component may be formed on battery 301 (step S17).

### Other Embodiments

Although a battery and a battery manufacturing method according to one or more aspects of the present disclosure have been described based on embodiments, the present disclosure is not limited to these embodiments. Various modifications of the embodiments as well as embodiments resulting from arbitrary combinations of elements of different embodiments that may be conceived by those skilled in the art are included within the scope of the present disclosure as long as these do not depart from the essence of the present disclosure.

For example, in what relationship the plurality of power generating layers 100 in a power generating element are connected is not limited to the examples described in the above embodiments. For example, the plurality of power generating layers 100 may all be connected in parallel or in series, and, alternatively, may be connected in any combination of series and parallel connections.

Changes, substitutions, additions, and deletions may be made in the above embodiments in various ways within the scope of the claims or their equivalents.

### INDUSTRIAL APPLICABILITY

The battery according to the present disclosure is applicable, for example, as a battery for electronic devices, electrical equipment, and electric vehicles.

1. A battery comprising:
a power generating element having a stacked structure of a plurality of power generating layers and a plurality of current collectors; and
a conductive component, wherein
each of the plurality of power generating layers includes an electrode layer, a counter electrode layer, and a solid electrolyte layer positioned between the electrode layer and the counter electrode layer, and is sandwiched between two adjacent current collectors among the plurality of current collectors,
two adjacent power generating layers among the plurality of power generating layers are stacked with one of the plurality of current collectors interposed therebetween,
the plurality of current collectors are not in contact with each other,
at least one current collector among the plurality of current collectors includes a protruding portion and a stacked portion, the protruding portion protruding beyond an end surface of the plurality of power generating layers in a side surface portion of the power generating element, the stacked portion being connected to the protruding portion on a side of the protruding portion where the end surface is located, and being a portion in which the plurality of power generating layers are stacked,
when the protruding portion and the stacked portion are projected from outside the side surface portion in a direction parallel to main surfaces of the plurality of power generating layers onto a projection plane perpendicular to the main surfaces of the plurality of power generating layers, a projected area of the protruding portion is larger than a projected area of the stacked portion,
the conductive component is connected to a main surface of the protruding portion, and
in the side surface portion, the conductive component contacts an end surface of the electrode layer or the counter electrode layer adjacent to the at least one current collector.

2. The battery according to claim 1, wherein
the protruding portion includes a bend or a curve.

3. The battery according to claim 2, wherein
a maximum angle of the bend or the curve included in the protruding portion is 90 degrees or less with respect to the stacked portion.

4. The battery according to claim 2, wherein
a maximum angle of the bend or the curve included in the protruding portion is between 1 and 45 degrees, inclusive, with respect to the stacked portion.

5. The battery according to claim 1, wherein
the protruding portion includes a portion that is thicker than the stacked portion.

6. The battery according to claim 5, wherein
the portion of the protruding portion that is thicker than the stacked portion has a maximum thickness that is at least 1.5 times a thickness of the stacked portion.

7. The battery according to claim 1, wherein
the protruding portion is bifurcated.

8. The battery according to claim 1, wherein
the side surface portion includes a region, located on both sides of the protruding portion in a direction parallel to the main surfaces of the plurality of power generating layers in the side surface portion, in which the at least one current collector does not protrude beyond the end surface of the plurality of power generating layers.

9. The battery according to claim 1, wherein
a length of protrusion of the protruding portion is at least twice a thickness of the stacked portion.

10. The battery according to claim 1, wherein
a height of a leading end of the protruding portion from the end surface of the plurality of power generating layers is less than or equal to a thickness of the power generating element.

11. The battery according to claim 1, wherein
a height of a leading end of the protruding portion from the end surface of the plurality of power generating layers is less than or equal to twice a thickness of one power generating layer among the plurality of power generating layers.

12. The battery according to claim 1, wherein
the plurality of power generating layers are electrically connected in parallel.

13. The battery according to claim 1, wherein
the plurality of power generating layers are electrically connected in series.

14. The battery according to claim 12, wherein
the plurality of current collectors include a counter electrode current collector electrically connected to the counter electrode layer and an electrode current collector electrically connected to the electrode layer,
the at least one current collector is the counter electrode current collector,
the battery further comprises, in the side surface portion, an insulating component that covers the electrode layer and the electrode current collector, and
in the side surface portion, the conductive component covers the insulating component and is connected to the protruding portion of the counter electrode current collector.

15. The battery according to claim 14, wherein
in the side surface portion, the insulating component contacts at least a portion of the solid electrolyte layer.

16. The battery according to claim 14, wherein
in the side surface portion, with respect to each of the plurality of power generating layers, the insulating component covers the electrode layer in the power generating layer and the electrode current collector electrically connected to the electrode layer in the power generating layer, and
in the side surface portion, with respect to each of the plurality of power generating layers, the conductive component is connected to the counter electrode current collector electrically connected to the counter electrode layer in the power generating layer.

17. A battery manufacturing method comprising:
preparing a plurality of unit cells each having a structure in which a power generating layer and a current collecting layer are stacked, the power generating layer including an electrode layer, a counter electrode layer, and a solid electrolyte layer positioned between the electrode layer and the counter electrode layer;
forming a stacked body in which: the plurality of power generating layers of the plurality of unit cells and a plurality of current collectors each including the current collecting layer are stacked; the plurality of power generating layers are each sandwiched between two adjacent current collectors among the plurality of current collectors; two adjacent power generating layers among the plurality of power generating layers are stacked with a current collector among the plurality of current collectors interposed therebetween; and the plurality of current collectors are not in contact with each other, the forming including stacking the plurality of unit cells and forming, on at least one current collector among the plurality of current collectors, a protruding portion that protrudes beyond an end surface of a power generating layer among the plurality of power generating layers in a side surface portion of the stacked body; and
forming a conductive component that is connected to a main surface of the protruding portion and, in the side surface portion, contacts an end surface of the electrode layer or the counter electrode layer adjacent to the at least one current collector, wherein
in the forming of the stacked body, the protruding portion is formed to have a projected area larger than a projected area of a stacked portion of the at least one current collector when the protruding portion and the stacked portion are projected from outside the side surface portion in a direction parallel to a main surface of the power generating layer onto a projection plane perpendicular to the main surface of the power generating layer, the stacked portion being connected to the protruding portion on a side of the protruding portion where the end surface is located, and being a portion in which the plurality of power generating layers are stacked.

18. The battery manufacturing method according to claim 17, wherein
in the forming of the stacked body, the protruding portion is formed using at least one of the following methods on a material: dissolving; partial cutting; polishing; sandblasting; brushing; etching; plasma irradiation; laser irradiation; mechanical cutting; ultrasonic cutting; or pressing.
